(19) United States
(12) Patent Application Publication
(10) Pub. No.: US 2025/0024339 A1
(43) Pub. Date: Jan. 16, 2025

(54) METHOD, APPARATUS AND SYSTEM RELATING TO A DUAL ACTIVE PROTOCOL STACK

(71) Applicant: Nokia Technologies Oy, Espoo (FI)

(72) Inventors: Amaanat ALI, Espoo (FI); Srinivasan SELVAGANAPATHY, Bangalore (IN); Ahmad AWADA, Munich (DE)

(21) Appl. No.: 18/712,504

(22) PCT Filed: Oct. 14, 2022
(86) PCT No.: PCT/EP2022/078605

§ 371 Date: May 22, 2024

(30) Foreign Application Priority Data
Nov. 24, 2021 (IN) 202141054168

(51) Int. Cl. H04W 36/18; H04W 36/00

(52) U.S. Cl. CPC H04W 36/185; H04W 36/00837

(57) ABSTRACT

A method is disclosed, e.g. performed by a user equipment, the method comprising: establishing a connection to a first master node, receiving a first reconfiguration message including configuration information for a secondary node addition including a first key, performing a random access to the secondary node, transmitting and/or receiving data towards/from the secondary node on one or more secondary cell group bearers using the first key, receiving a second reconfiguration message relating to an inter-master node handover from the first master node to a second master node, the reconfiguration message comprising configuration information relating to a dual active protocol stack (DAPS) for one or more secondary cell group bearers associated with the secondary node and a second key; establishing the dual active protocol stack for the one or more secondary cell group bearers of the secondary node based on the configuration information; transmitting and/or receiving data towards/from the secondary node on the one or more secondary cell group bearers using the first key hosted by the dual active protocol stack for the one or more secondary cell group bearers; performing a random access to the second master node; transmitting a reconfiguration complete message to the second master node; and transmitting and/or receiving data towards/from the secondary node for the one or more secondary cell group bearers using the second key hosted by the dual active protocol stack for the one or more secondary cell group bearers. Related methods that may be performed by network nodes are disclosed. Further, a corresponding system and corresponding apparatuses, computer programs, and computer-readable storage media are disclosed.

### TECHNICAL FIELD

Various example embodiments relate to a dual active protocol stack, in particular to its use for transmitting and/or receiving data on one or more secondary cell group bearers.

### BACKGROUND

In cellular networks, a user equipment (UE) may be connected to a network node. The network node may for instance be an evolved NodeB (eNB) in a cellular network providing long term evolution (LTE) functionality and/or a 5G NodeB (gNB) in a cellular network providing 5G functionality.

For various reasons, the connection between a UE and a network node may be interrupted. One example reason is mobility of a UE, i.e. users and their user equipment (UE) may move through cellular networks. This mobility may cause situations where the UE may need to change its connection from a serving node to a target node. This is referred to as handover.

In addition to the scenario where the UE is connected to one network node, in various scenarios, a UE may be configured to utilise resources provided by two different nodes that are e.g. connected via backhaul. In such scenarios, one node may act as the master node (MN) and the other as the secondary node (SN). The MN and SN may be connected via a network interface and at least the MN may be connected to the core network. In such scenarios, changes in the connection between the UE and one of the network nodes, e.g. a change of a MN, may have effects on the connection between the UE and the other network nodes, e.g. the connection between a UE and a SN.

### SUMMARY

According to a first example aspect, a user equipment is disclosed, the user equipment comprising at least one processor; and at least one memory including computer program code; the at least one memory and the computer program code configured to, with the at least one processor, cause the user equipment at least to perform the following:
establish a connection to a first master node,
receive a first reconfiguration message including configuration information for a secondary node addition including a first key,
perform a random access to the secondary node,
transmit and/or receive data towards/from the secondary node on one or more secondary cell group bearers using the first key,
receive a second reconfiguration message relating to an inter-master node handover from the first master node to a second master node, the reconfiguration message comprising configuration information relating to a dual active protocol stack (DAPS) for one or more secondary cell group bearers associated with the secondary node and a second key;
establish the dual active protocol stack for the one or more secondary cell group bearers of the secondary node based on the configuration information;
transmit and/or receive data towards/from the secondary node on the one or more secondary cell group bearers using the first key hosted by the dual active protocol stack for the one or more secondary cell group bearers;
perform a random access to the second master node;
transmit a reconfiguration complete message to the second master node; and
transmit and/or receive data towards/from the secondary node for the one or more secondary cell group bearers using the second key hosted by the dual active protocol stack for the one or more secondary cell group bearers.

The user equipment (UE) according to the first example aspect as described above will also be referred to as the apparatus according to the first example aspect in the following. It may be a UE of a cellular network, for instance a 3G, LTE/4G, 5G NR, 5G or 6G network. Further, it may be a mobile device, e.g. a handset, a smartphone, a tablet, a laptop, or any other mobile device. In various embodiments, it may be a vehicle for travelling in air, water, or on land, e.g. a plane or a drone, a ship or a car or a truck. It may also be a robot, a sensor device, a wearable device, an Internet of Things (IoT) device, a Machine Type Communication (TC) device, or the likes.

According to a second example aspect a network node is disclosed, the network node comprising at least one processor; and at least one memory including computer program code; the at least one memory and the computer program code configured to, with the at least one processor, cause the network node at least to perform the following:
receiving, from a second master node acting as a target master node of an inter-master node handover for a user equipment, a secondary node addition request;
transmitting, to the target master node, a secondary node addition response comprising information relating to a configuration of a dual active protocol stack for one or more secondary cell group bearers by the user equipment, the network node being associated with the one or more secondary cell group bearers;
receiving, from a first master node acting as a source master node of the inter-master node handover for the user equipment, a secondary node release request;
transmitting, to the source master node, a secondary node release response;
transmitting and/or receiving data towards/from the user equipment on the one or more secondary cell group bearers using a first key, wherein the first key is based at least on information relating to the source master node;
receiving, from the target master node, a message indicating that the target master node has received a reconfiguration complete message from the user equipment; and
transmitting and/or receiving data towards/from the user equipment on the one or more secondary cell group bearers using a second key, wherein the second key is based at least on information relating to the target master node.

The network node according to the second example aspect may act as a secondary node (SN) in various embodiments and may thus be referred to as secondary node.

According to a third example aspect a network node is disclosed, the network node comprising at least one processor; and at least one memory including computer program code; the at least one memory and the computer program code configured to, with the at least one processor, cause the network node at least to perform the following:
transmitting, to a second master node acting as a target master node of an inter-master node handover for a user equipment, a handover request comprising information relating to one or more second cell group bearers associated with a secondary node;
receiving, from the target master node, a handover request acknowledgement comprising information relating to a configuration of a dual active protocol stack for the one or more secondary cell group bearers by the user equipment;
transmitting, to the secondary node, a secondary node release request;
receiving, from the secondary node, a secondary node release response; and
transmitting, to the user equipment, a reconfiguration message relating to the inter-master node handover from the source master node to the target master node, the reconfiguration message comprising configuration information comprising at least the information relating to the configuration of the dual active protocol stack for the one or more secondary cell group bearers by the user equipment.

In various embodiments, the network node according to the third example aspect may act as a source master node of an inter-master node handover and may thus be referred to as a source master node.

According to a fourth example aspect, a network node is disclosed, the network node comprising at least one processor; and at least one memory including computer program code; the at least one memory and the computer program code configured to, with the at least one processor, cause the network node at least to perform the following:
receiving, from a first master node acting as a source master node of an inter-master node handover for a user equipment, a handover request comprising information relating to one or more secondary cell group bearers associated with a secondary node;
determining, at least based on the handover request, whether to maintain the secondary node;
on condition that it has been determined to maintain the secondary node:
   transmitting, to the secondary node, a secondary node addition request;
   receiving, from the secondary node, a secondary node addition response comprising information relating to a configuration of a dual active protocol stack for one or more secondary cell group bearers by the user equipment;
   transmitting, to the source master node, a handover request acknowledgement comprising at least the information relating to the configuration of the dual active protocol stack for the one or more secondary cell group bearers by the user equipment;
   receiving a random access request from the user equipment;
   receiving a reconfiguration complete message from the user equipment; and
   transmitting, to the secondary node, a message indicating that the target master node has received a reconfiguration complete message from the user equipment.

In various embodiments, the network node according to the fourth example aspect may act as a target master node of an inter-master node handover and may thus be referred to as target master node.

Additionally, a system is disclosed, the system comprising at least four apparatuses, e.g. comprising a UE according to the first example aspect, a network node according to the second example aspect, a network node according to the third example aspect, and a network node according to the fourth example aspect.

Any disclosure herein relating to any example aspect is to be understood to be equally disclosed with respect to any subject-matter according to the respective example aspect, e.g. relating to an apparatus, a method, a computer program, and a computer-readable medium. Thus, for instance, the disclosure of a method step shall also be considered as a disclosure of means for performing and/or configured to perform the respective method step. Likewise, the disclosure of means for performing and/or configured to perform a method step shall also be considered as a disclosure of the method step itself. The same holds for any passage describing at least one processor; and at least one memory including computer program code; the at least one memory and the computer program code configured to, with the at least one processor, cause an apparatus at least to perform a step.

For convenience, a list of abbreviations used in the following is already given at this point:
CA Carrier Aggregation
C-RNTI Cell RNTI
DAPS Dual Active Protocol Stack
DC Dual Connectivity
DCCA Dual Connectivity Carrier Aggregation
DL Downlink
E-UTRA Evolved Universal Terrestrial Radio Access
gNB 5G Node-B
HO Handover
LTE Long Term Evolution
MAC Medium Access Control
MCG Master Cell Group
MIB Master Information Block
MN Master Node
MR-DC Multi-Radio Dual Connectivity
NGEN-DC NG-RAN E-UTRA-NR Dual Connectivity
NR New Radio
PCell Primary Cell
PDCP Packet Data Convergence Protocol
PRACH Physical Random Access Channel
PS Protocol Stack
PSCell Primary SCG cell
RACH Random Access Channel
RAN Radio Access Network
RB Radio Bearer
RLC Radio-Link Control
RNTI Radio Network Temporary Identifier
ROHC Robust Header Compression
RRC Radio Resource Control
SCG Secondary Cell Group
SgNB Secondary gNB
SN Secondary Node
SRB Signalling Radio Bearer
SSB Synchronization Signal Block
TX/RX Transceiver
UE User Equipment
UL Uplink

In the following, example details and example embodiments of the various example aspects introduced above will be described.

To that end, it is first referred back to the description above. There, it was explained that in various scenarios, a UE may be configured to utilise resources provided by two different nodes that are e.g. connected via backhaul. In such scenarios, one node may act as the master node (MN) and the other as the secondary node (SN). The MN and SN may be connected via a network interface and at least the MN may be connected to the core network. This configuration may allow e.g. to provide higher data rates to a UE by additionally using a SN while still being able to provide control functionality via the MN. Thus, the SN may not have a control plane connection to the core network while still providing additional resources to the UE. For example in the context of 5G, it may be an en-gNB (in EN-DC), a Secondary ng-eNB (in NE-DC) or a Secondary gNB (in NR-DC and NGEN-DC).

The SN may be associated with a group of serving cells, for example in the context of Multi Radio-Dual Connectivity (MR-DC). This group of serving cells may be referred to as Secondary Cell Group (SCG).

The MN may similarly be associated with a group of serving cells. This group of serving cells may be referred to as a Master Cell Group (MCG).

Having a UE configured to utilise resources provided by a MN and a SN may mean that a UE is provided with two different group of serving cells, i.e. a MCG and a SCG. Against this background, it may be useful to define channels on which the data is transferred from one of the nodes to the UE and/or the other way around, e.g. on different protocol layers, so for example on layer 2. Such channels may be referred to as radio bearers.

Various types of radio bearers may be defined. For example, SCG bearers may be such radio bearers with one or more radio-link control (RLC) bearers, e.g. only, in the SCG. Thus, SCG bearers may for instance be such radio bearers which, e.g. only, use SCG radio resources for transferring data to and from a UE. Similarly, MCG bearers could be such radio bearers which, e.g. only, use MCG radio resources for transferring data to and from a UE. Further radio bearers could be defined, e.g. a split radio bearer which may for instance be a radio bearer with RLC bearers both in MCG and SCG.

Consequently, a UE may use different radio bearers such as one or more SCG bearers for transferring, e.g. transmitting and/or receiving, data from and to the network, e.g. from and to the MN and/or the SN.

According to the first example aspect, a UE may perform the following:
establish a connection to a first master node,
receive a first reconfiguration message including configuration information for a secondary node addition including a first key,
perform a random access to the secondary node,
transmit and/or receive data towards/from the secondary node on one or more secondary cell group bearers using the first key.

Thus, a UE may first establish a connection to a network node. The network node may, later on, act as a source master node in a handover. The network node may inform the UE that a secondary node with one or more SCG bearers should be used. The network node may use e.g. a RRC Reconfiguration message as first reconfiguration message. The first reconfiguration message may comprise a first key. The first key may be used to encrypt/decrypt data that is transferred on the one or more SCG bearers of the SN. Triggered by the first reconfiguration message, the UE may perform a random access to the secondary node, e.g. to establish a connection to the secondary node. After having completed the random access procedure, the UE and the secondary node may be able to exchange data using the first key on the one or more SCG bearers.

According to the first example aspect, a UE may perform the following:
receive a second reconfiguration message relating to an inter-master node handover from the first master node to a second master node, the reconfiguration message comprising configuration information relating to a dual active protocol stack (DAPS) for one or more secondary cell group bearers associated with the secondary node and a second key;
establish the dual active protocol stack for the one or more secondary cell group bearers of the secondary node based on the configuration information.

The first MN (which may act as a source master node and thus, for ease of understanding, is also referred to as “source master node”) may be the MN by which the UE is served before the inter-MN HO, e.g. after the connection has been established as described above. The MN by which the UE is to be served after the inter-MN HO may be referred to as second MN (or, for ease of understanding, “target MN”).

The second reconfiguration message relating to an inter-master node handover from a source master node to a target master node may e.g. be a RRC Reconfiguration message. The source MN may add the configuration information, e.g. DAPS-Config, for selected SCG bearers for which interruption free or reduced HO is desired or required to the second reconfiguration message. The configuration information, e.g. the DAPS-Config, may comprise the configuration to establish/initiate a DAPS, e.g. PDCP DAPS, for one or more, e.g. selected, SCG bearers so that the DAPS may host two security layers for ciphering and integrity protection. A first layer of such two security layers may be using a first SN key derived from a source MN key and a second layer may be using a second SN key derived from the target MN key.

Initiating the dual active protocol stack (DAPS) for the one or more secondary cell group (SCG) bearers may be understood in the following context A DAPS may be a protocol stack that hosts functionality for one or more protocol layers (or protocol layer entities) for two connections. It may be configured to be used when a UE has to switch e.g. a radio bearer such as a SCG bearer from one connection to another. For example, a UE may use a single protocol stack for a single connection. Then, the UE may be configured to switch to a second connection. To that end, the UE may configure a DAPS, e.g. to add protocol functionality for the second connection. Thus, for some time, the UE may use the DAPS to still maintain a first connection while already using a second connection. After the connection has been switched, the UE may perform another configuration so that the protocol stack relating to the first connection is released while a single protocol stack relating to the second connection is maintained. The first connection may be referred to as source and the second connection may be referred to as target.

When the UE establishes a DAPS for one or more SCG bearers, it may establish a radio-link control (RLC) entity for a target for each of the one or more SCG bearers. Further, it may reconfigure a PDCP entity for the SCG bearers with separate security and/or Robust Header Compression (ROHC) functions for source and target and e.g. associate them with the RLC entities configured by source and target, respectively. It may further retain some or all of the rest of the, e.g. previously used, source configurations until release of the source. The DAPS may in particular be a PDCP DAPS.

The DAPS may also host keys, e.g. a first key which is e.g. related to the source and e.g. a second key which is e.g. related to the target. The first key may for instance be used to encode and/or decode or encrypt and/or decrypt data on the source. The second key may for instance be used to encode and/or decode data on the target. The first and/or second key may be hosted by a DAPS e.g. as part of the security functions for source and target, respectively. These keys may be used by a user equipment. In various embodiments, the UE may configure for the secondary node (SN) connection during handover a DAPS Packet Data Convergence Protocol (PDCP) hosting two security layers for ciphering and integrity protection: a first layer using the first SN key derived from a first Master node (MN) key and a second layer using the second SN key derived from a second MN key.

In various embodiments, the UE may further, as part of the establishing of the DAPS, create a MAC entity for the target in the DAPS. However, in other embodiments, the UE uses a common MAC entity for source and target. For instance, in various embodiments, the UE may configure for the secondary node (SN) connection during handover a DAPS Packet Data Convergence Protocol (PDCP) hosting two different security layers and one common Medium Access Control (MAC) layer, as will be explained in more detail below.

According to the first example aspect, the UE may further perform the following:
transmit and/or receive data towards/from the secondary node on the one or more secondary cell group bearers using the first key hosted by the dual active protocol stack for the one or more secondary cell group bearers;
perform a random access to the second master node;
transmit a reconfiguration complete message to the second master node; and
transmit and/or receive data towards/from the secondary node for the one or more secondary cell group bearers using the second key hosted by the dual active protocol stack for the one or more secondary cell group bearers.

Transmitting and/or receiving data towards/from the SN on the one or more SCG bearers may refer to (e.g. only) transmitting. However, it may also refer to (e.g. only) receiving. Lastly, it may also refer to both, transmitting and receiving. The data may for example be user data. The one or more SCG bearers may be SN or MN terminated. The transmitting and receiving of the data on the one or more secondary cell group bearers may be from and to the SN that is associated with the one or more SCG bearers. Further, in various embodiments, there may be a time interval where transmitting and/or receiving data is possible both using the first key and using the second key, e.g. essentially “simultaneously”. However, in other embodiments, transmitting and/or receiving data on the one or more SCG bearers using a first key and a second key may be performed one after another, e.g. first data is transmitted and/or received on the one or more SCG bearers using a first key. Then there may be a switch to the second key. Then, transmitting and/or receiving data on the one or more SCG bearers is done using the second key.

The switch may be associated with a, e.g. successfully, performed random access (e.g. procedure) to the target MN. The random access may be used e.g. to synchronize the UE to the target MN as part of the inter-MN HO. Having performed the random access, e.g. successfully, may mean that the UE can now be served by the target MN, e.g. transmit and/or receive e.g. user data to and from the target MN. The UE may inform the target master node that it has been successfully reconfigured to now be served by the target MN. Accordingly, the UE may transmit the reconfiguration complete message to the target master node after having completed the random access to the target master node.

It was described above how a UE may establish a DAPS for one or more SCG bearers and transmit and/or receive data on the one or more SCGs using a first and a second key. Details of this procedure may differ in various embodiments.

By way of example, in a first group of embodiments, the UE perform the following:
use a common medium access control entity for the transmitting and/or receiving of the data towards/from the secondary node on the one or more secondary cell group bearers using the first key hosted by the dual active protocol stack and for the transmitting and/or receiving of the data towards/from the secondary node on the one or more secondary cell group bearers using the second key hosted by the dual active protocol stack.

Accordingly, when establishing the DAPS for the one or more SCG bearers, the UE may establish a radio-link control (RLC) entity for target for each of the one or more SCG bearers and reconfigure a PDCP entity for the SCG bearers with separate security and/or Robust Header Compression (ROHC) functions for source and target and e.g. associate them with the RLC entities configured by source and target, respectively, as described above. However, it may not create a separate MAC entity for the transmitting and/or receiving of the data on the one or more secondary cell group bearers using the second key. Thus, in various embodiments the UE does not reset the MAC when initiating the DAPS. In various embodiments, this may have the advantage that the UE may not need to have two simultaneous TX/RX physical layer operations and/or MAC will remain common between source and target SCG PS.

Whether to use a common MAC as described above may be indicated in the second reconfiguration message, e.g. by parts of the configuration information. In particular, the second reconfiguration message and/or the configuration information may comprise e.g. a parameter which may be e.g. referred to as “DAPS-with-common-MAC”. The parameter may e.g. indicate that the same PSCell, e.g. secondary node, is retained during handover. One or more further parameters may be comprised in the second reconfiguration message and/or the configuration information. For example, a parameter indicating whether a reconfiguration with synchronization is to be performed by a UE. The parameter may be referred to as “reconfWithSync”. In various embodiments, the second reconfiguration message comprises: Master Cell Group (MCG) configuration information, Secondary Cell Group (SCG) configuration information without reconfig with Sync, and SCG Radio Bearer (RB) configuration for DAPS with Medium Access Control (MAC) retained.

Accordingly, in various embodiments, the UE may perform the following:
determine, based at least on the configuration information comprised in the second reconfiguration message, whether to use the common medium access control entity or whether to reset the medium access control entity after the transmitting and/or receiving of the data towards/from the secondary node on the one or more secondary cell group bearers using the first key hosted by the dual active protocol stack and/or before the transmitting and/or receiving of the data towards/from the secondary node on the one or more secondary cell group bearers using the second key hosted by the dual active protocol stack.

If the UE has determined to use the common MAC entity based on the configuration information, it may continue to receive data, e.g. user packets, for the one or more SCG bearers using the first, e.g. SN, key and e.g. the “old” C-RNTI, i.e. the C-RNTI that was used to communicate with the UE before the handover was triggered, for example as long as the handover execution/random access is not completed to the target MN.

In various embodiments, the UE may perform the following:
switch from the transmitting of the data towards the secondary node for the one or more secondary cell group bearers using the first key hosted by the dual active protocol stack to the transmitting of the data towards the secondary node for the one or more secondary cell group bearers using the second key hosted by the dual active protocol stack after the random access to the second master node has been completed and after the reconfiguration complete message has been transmitted to the second master node.

The switching may be triggered if the user equipment determines that the random access to the target master node has been completed and the reconfiguration complete message has been transmitted to the target master node (and possibly on one or more further predetermined conditions are met). In various embodiments, the switching from using the first key for transmitting data on the one or more SCG bearers to using the second key for transmitting data on the one or more SCG bearers may be based on the UE performing or completing the RACH procedure with the MCG, e.g. the target master node. This may involve an indication from the MCG component and RACH success to SCG-DAPS layer within the UE. After such a switching of the uplink, the transmitting using the second key using a single protocol stack may start e.g. after, in response or in reaction to when SN sends (and, thus, UE receives) information, e.g. PDCCH with “new” CRNTI.

Also the SN may start transmitting data which is received by the UE as DL data using the second key. The point at which the SN may start transmitting the respective data, i.e. data to the UE, using the second key may be for example after, e.g. successful, target MN RACH access procedure by the UE and e.g. the UE sending RRC Reconfiguration Complete to the target MN, which may for instance be indicated to the SN in a message from the target MN. Then the UE may stop sending data, e.g. new packets, for the one or more SCG bearers using the first SN key and switch to the second key and apply the “new” C-RNTI.

In a second group of embodiments, the UE may not use a common MAC entity. For example, the UE may determine to reset the MAC entity.

Accordingly, when initiating the DAPS for the one or more SCG bearers, the UE may establish a radio-link control (RLC) entity for the target for each of the one or more SCG bearers and reconfigure a PDCP entity for the SCG bearers with separate security and/or Robust Header Compression (ROHC) functions for respective source and target and e.g. associate them with the RLC entities configured by source and target, respectively, as described above. Further, it may create a separate MAC entity for the transmitting and/or receiving of the data on the one or more secondary cell group bearers using the second key.

Accordingly, in various embodiments, the UE may perform the following:
perform a random access to the secondary node associated with the one or more secondary cell group bearers; and
start the transmitting and/or receiving of the data towards/from the secondary node on the one or more secondary cell group bearers using the second key hosted by the dual active protocol stack after the random access to the second master node and the random access to the secondary node have been completed.

For example after receiving the second reconfiguration message comprising the configuration information, the UE may continue to receive data, e.g. user packets, for the one or more SCG bearers using the first SN key and e.g. the “old” C-RNTI. The “old” C-RNTI may be understood to be the C-RNTI that was used to communicate with the UE before the handover is triggered, e.g. as long as the handover execution/random access is not completed to the target MN and SN. After the, e.g. successful, random access to the target MN and the target SN is completed, the UE may start to send/receive UL/DL data on the one or more SCG bearers using the first and second keys. There may be a time interval where both keys may be used, e.g. essentially “simultaneously”.

In various embodiments, a network, a UE, or a network node may be capable of performing an inter-MN HO retaining the PScell using a common MAC entity and performing an inter-MN HO retaining the PSCell resetting a MAC entity. Accordingly, in various embodiments, a network, a network node and/or UE may for instance determine based on the UE's capabilities whether to transmit configuration information that will result in that the UE initiates/establishes a DAPS for one or more SCG bearers using a common MAC or in that the UE initiates/establishes a DAPS for the one or more SCG bearers involving creating a new MAC entity for the target.

In various embodiments, regardless of whether a common MAC entity is used or not, the user equipment may stop using the DAPS, e.g. after one or more reconfigurations have been completed, and continue the transmitting and/or receiving of data using the second key using (e.g. only) a single protocol stack.

In various embodiments, the UE may perform the following:
receive a reconfiguration message from the secondary node associated with the one or more secondary cell group bearers, the reconfiguration message comprising configuration information relating to a use of a single protocol stack for the one or more secondary cell group bearers;
based at least on the configuration information received from the secondary node, initiate the use of the single protocol stack for transmitting and/or receiving data towards/from the secondary node on the one or more secondary cell group bearers using the second key; and
transmit a reconfiguration complete message to the secondary node.

Initiating the use of the single protocol stack may involve terminating the use of the DAPS. In particular, it may involve releasing configurations from the DAPS that relate to the first key and/or configurations that were used and/or needed for transmitting and/or receiving data on the one or more secondary cell group bearers using the first key. Thus, it may correspond to reconfiguring the one or more SCG bearers with NR DAPS PDCP back to NR PDCP. In various embodiments, the UE receives a third reconfiguration message including information related to release of the first master node, and configures for the secondary node (SN) connection a Packet Data Convergence Protocol (PDCP) hosting the second key.

The reconfiguration message comprising the configuration information may be for example a RRC Reconfiguration message. It may comprise information indicating and/or triggering the initiating of the use of the single protocol stack and/or the release of configurations from the DAPS that relate to the first key and/or configurations that were used and/or needed for transmitting and/or receiving data on the one or more secondary cell group bearers using the first key.

Establishing a DAPS and transmitting and/or receiving data on the one or more SCG bearers using a first and a second key may allow reducing the data interruption time, e.g. in scenarios where a key needs to be changed from a first key to a second key. One example for such a scenario is an inter-MN HO during which the SCG configuration or at least the primary SCG cell (PSCell), e.g. a secondary node, remains the same.

However, the same effects may also be achieved in various other scenarios.

Therefore, a user equipment is disclosed, the user equipment comprising at least one processor; and at least one memory including computer program code; the at least one memory and the computer program code configured to, with the at least one processor, cause the user equipment at least to perform the following:
establish a connection to a first network node,
receive a first reconfiguration message including configuration information including a firstkey,
transmit and/or receive data towards/from the first network node on one or more bearers using the first key,
receive a second reconfiguration message comprising configuration information relating to a dual active protocol stack (DAPS) for one or more bearers associated with the first network node and a second key;
establish the dual active protocol stack for the one or more bearers of the first network node based on the configuration information and configure for the first network node connection a DAPS Packet Data Convergence Protocol (PDCP) hosting two different security layers with the first and the second keys and one common Medium Access Control (MAC) layer,
transmit and/or receive data towards/from the first network node on the one or more bearers using the first key hosted by the dual active protocol stack for the one or more bearers; and
transmit and/or receive data towards/from the first network node for the one or more bearers using the second key hosted by the dual active protocol stack for the one or more bearers.

It is to be understood that the user equipment described above may also be used in scenarios different from the inter-MN handover scenario considered in various embodiments of the first to fourth example aspects. The handover scenario may be understood to be a special case, e.g. in various embodiments, the user equipment may further be configured to operate in dual connectivity connection with a first master node and a secondary node, wherein the first reconfiguration message is received from the first master node, wherein the second reconfiguration message is received from the first master node and comprises configuration information relating to a handover from the first master node to a second master node while maintaining connection to the secondary node, and wherein the first network node is the secondary node.

Some example embodiments have been described above with a particular focus on a UE according to the first example aspect. Some example embodiments will now be described in more detail with a particular focus on network nodes according to the second, third and fourth example aspects. It is to be understood that the description provided with regard to the UE according to the first example aspects also applies to the network nodes according to the second, third and fourth example aspects

In various embodiments, a network node according to the third example aspect, e.g. a source master node of an inter-master node handover for a user equipment, may perform the following:
transmitting, to the secondary node, a secondary node modification request;
receiving, from the secondary node, a secondary node modification response comprising information relating to one or more secondary cell group bearers associated with the secondary node.

Accordingly, in various embodiments, a network node according to the second example aspect, e.g. a secondary node, may perform the following:
receiving, from the source master node, a secondary node modification request;
transmitting, to the source master node, a secondary node modification response comprising information relating to the one or more secondary cell group bearers.

Thus, the SN may provide, in the secondary node modification response, information to the source MN that e.g. indicate whether there are one or more SCG bearers which can e.g. possibly benefit from DAPS features, for instance XR bearers.

The source MN may then, e.g. as described before, transmit a handover request to the target MN comprising this information (or at least part thereof) relating to the one or more SCG bearers. Thereby, the source MN may inform the target MN to prepare the DAPS configuration for these one or more SCG bearers.

The decision whether to initiate an inter-master node handover for the UE may be taken by the source MN, e.g. before transmitting the handover request.

Accordingly, in various embodiments, a network node according to the fourth example aspect, e.g. a source master node of an inter-master node handover for a user equipment, may perform the following:
receiving, from the user equipment, a measurement report;
triggering, based on the measurement report, the inter-master node handover.

The measurement report may be transmitted by the UE to the source MN, e.g. in response to a request or upon detecting that a predefined condition is met, e.g. a received signal quality is below a predefined threshold. Additionally or alternatively, the UE may transmit the measurement report to the first master node to trigger a handover, e.g. without request from the source MN.

In various embodiments, a network node according to the third example aspect, e.g. a source master node of an inter-master node handover for a user equipment, may perform the following:
transmitting, to a second master node acting as a target master node of an inter-master node handover for a user equipment, a handover request comprising information relating to one or more second cell group bearers associated with a secondary node.

In various embodiments, a network node according to the fourth example aspect, e.g. a target master node of an inter-master node handover for a user equipment, may perform the following:
receiving, from a first master node acting as a source master node of an inter-master node handover for a user equipment, a handover request comprising information relating to one or more secondary cell group bearers associated with a secondary node;
determining, at least based on the handover request, whether to maintain the secondary node.

Thus, the target MN may receive, via the source MN, information relating to the one or more secondary cell group bearers associated with the secondary node. Based on this information, the network node may determine, e.g. decide, whether to maintain the SN. In various embodiments, the information may have been originally at least partly provided by the SN to the source MN, as described before.

In various embodiments, a network node according to the fourth example aspect, e.g. a target master node of an inter-master node handover for a user equipment, may perform the following, e.g. on condition that it has been determined to maintain the secondary node:
transmitting, to the secondary node, a secondary node addition request;
receiving, from the secondary node, a secondary node addition response comprising information relating to a configuration of a dual active protocol stack for one or more secondary cell group bearers by the user equipment;
transmitting, to the source master node, a handover request acknowledgement comprising at least the information relating to the configuration of the dual active protocol stack for the one or more secondary cell group bearers by the user equipment;
receiving a random access request from the user equipment.

If the network node determines to maintain the SN, it may, under various circumstances, e.g. if various further conditions are met, be beneficial if the UE can use a DAPS for one or more SCG bearers. Thus, target MN may request, from the secondary node, the information relating to the configuration of the dual active protocol stack for the one or more secondary cell group bearers by the user equipment. The network node may do so by transmitting a SN addition request to the SN. In response, the network node may receive, from the SN, information relating to the configuration of a dual active protocol stack for one or more SCG bearers by a UE. It may then provide, to the source MN of the inter-master node handover, at least the information relating to the configuration of the dual active protocol stack for the one or more secondary cell group bearers by the user equipment.

In various embodiments, the target master node may provide further information in addition to the information relating to the configuration of the dual active protocol stack for the one or more secondary cell group bearers by the user equipment in the handover request acknowledgement.

As described before, the information relating to the configuration of the dual active protocol stack for the one or more secondary cell group bearers by the user equipment may comprise a SCG configuration. The target master node may additionally provide e.g. a MCG configuration.

If the network node determines not to maintain the SN, there may, under various circumstances, be no reason for the UE to establish and/or use a DAPS for one or more SCG bearers that are associated with the SN. Thus, the inter-MN HO may proceed without the UE using a DAPS. Consequently, the target MN may in this case not request from the SN the information relating to the configuration of the dual active protocol stack for the one or more secondary cell group bearers by the UE. Accordingly, the SN may not send corresponding information in response and the target MN may not provide the information to the source MN.

In various embodiments, a network node according to the second example aspect, e.g. a secondary node, may perform the following:
receiving, from a second master node acting as a target master node of an inter-master node handover for a user equipment, a secondary node addition request;
transmitting, to the target master node, a secondary node addition response comprising information relating to a configuration of a dual active protocol stack for one or more secondary cell group bearers by the user equipment, the network node being associated with the one or more secondary cell group bearers.

Thus, the secondary node may be added as secondary node by the target MN. The secondary node may, as it is associated with the one or more SCG bearers, provide information on how a DAPS can be configured by the user equipment for the one or more SCG bearers. The information may also comprise e.g. a parameter “reconfWithSync” which may for instance, inter alia indicate to the UE whether to perform predefined actions corresponding to predefined values of the “reconfWithSync” parameter. Further, the information may indicate whether a common MAC entity is to be used by the UE, e.g. a “DAPS-with-common-MAC” parameter. As described, the information may be provided in response to a request, e.g. a request for information relating to a configuration of a dual active protocol stack for one or more secondary cell group bearers by a user equipment, e.g. comprised in a SN addition request.

In various embodiments, a network node according to the third example aspect, e.g. a source master node of an inter-master node handover for a user equipment, may perform the following:
receiving, from the target master node, a handover request acknowledgement comprising information relating to a configuration of a dual active protocol stack for the one or more secondary cell group bearers by the user equipment;
transmitting, to the secondary node, a secondary node release request;
receiving, from the secondary node, a secondary node release response.

In various embodiments, a network node according to the second example aspect, e.g. a secondary node, may perform the following:
receiving, from a first master node acting as a source master node of the inter-master node handover for the user equipment, a secondary node release request;
transmitting, to the source master node, a secondary node release response.

By exchanging a SN release request and a SN release response, the target MN may release the SN. Releasing the secondary node may be part of the inter-MN HO, where the secondary node switches from being a SN of the source MN of the inter-MN HO to being a SN of the target MN of the inter-MN HO. Accordingly, as was described above, the target MN may add the SN, e.g. transmitting a SN addition request and/or receiving a SN addition response, and the source MN may release the SN. Releasing the SN may be done by the source MN in reaction to receiving the handover request acknowledgement from the target master node.

In various embodiments, a network node according to the third example aspect, e.g. a source master node of an inter-master node handover for a user equipment, may perform the following:
transmitting, to the user equipment, a reconfiguration message relating to the inter-master node handover from the source master node to the target master node, the reconfiguration message comprising configuration information comprising at least the information relating to the configuration of the dual active protocol stack for the one or more secondary cell group bearers by the user equipment.

The configuration information may be the configuration information based on which the UE establishes the DAPS, as described above, e.g. a RRC reconfiguration message comprising a SCG and/or target MCG configuration and, possibly e.g. a parameter for indicating whether to retain a MAC. Thus, the reconfiguration message may correspond to the “second” reconfiguration message described with respect to embodiments of the first example aspect.

The UE may, e.g. triggered by at least receiving the reconfiguration message comprising the configuration information, establish the DAPS for the one or more SCG bearers, transmit and/or receive data on the one or more SCG bearers using the first key hosted by the DAPS, perform a random access to the target MN, transmit a reconfiguration complete message to the target MN and/or transmit and/or receive data on the one or more SCG bearers using the second key hosted by the DAPS, as described before.

In various embodiments, a network node according to the fourth example aspect, e.g. a target master node of an inter-master node handover for a user equipment, may perform the following, e.g. on condition that it has been determined to maintain the secondary node:
receiving a random access request from the user equipment;
receiving a reconfiguration complete message from the user equipment; and
transmitting, to the secondary node, a message indicating that the target master node has received a reconfiguration complete message from the user equipment.

In various embodiments, a network node according to the second example aspect, e.g. a secondary node, may perform the following:
transmitting and/or receiving data towards/from the user equipment on the one or more secondary cell group bearers using a first key, wherein the first key is based at least on information relating to the source master node;
receiving, from the target master node, a message indicating that the target master node has received a reconfiguration complete message from the user equipment; and
transmitting and/or receiving data towards/from the user equipment on the one or more secondary cell group bearers using a second key, wherein the second key is based at least on information relating to the target master node.

The transmitting and/or receiving of data may in particular correspond to transmitting the data to the UE and receiving data from the UE, e.g. using the one or more SCG bearers. The data may be user data and it may be encodable and/or decodable or encryptable and/or decryptable using the first or second key, respectively.

In various embodiments, the transmitting and/or receiving of the data on the one or more secondary cell group bearers using a second key does not mean that there can be no transmitting and/or receiving of data on the one or more SCG bearers using the first key. However, in other embodiments, transmitting and/or receiving data on the one or more SCG bearers using the second key may indicate that transmitting and/or receiving of data on the one or more SCG bearers using the first key is no longer possible.

The reception of the random access request may trigger that the target MN and the UE perform and complete the RA (e.g. procedure). The target master node of the inter-master node handover may then, e.g. after completing the RA (e.g. procedure) and/or receiving a RRC Reconfiguration Complete message from the UE, transmit a secondary gNB (SgNB) reconfiguration complete message to the SN.

Further messages and/or procedures, e.g. between the UE and the SN, may happen after that, e.g. depending on whether a common MAC entity is used or not. This will be discussed in more detail below.

It was previously described that, in various embodiments, the UE may use a common medium access control entity for the transmitting and/or receiving of the data on the one or more secondary cell group bearers using the first key hosted by the dual active protocol stack and for the transmitting and/or receiving of the data on the one or more secondary cell group bearers using the second key hosted by the dual active protocol stack. The network nodes according to the second, third and fourth aspect may be adapted to this.

Thus, in various embodiments, the information relating to the configuration of the dual active protocol stack for the one or more secondary cell group bearers by the user equipment provided by the network node according to the second example aspect, e.g. the secondary node, may comprise information for the user equipment for using a common medium access control entity for the transmitting and/or receiving of the data towards/from the secondary node on the one or more secondary cell group bearers using the first key and for the transmitting and/or receiving of the data towards/from the secondary node on the one or more secondary cell group bearers using the second key. Similarly, in various embodiments, the information relating to the configuration of the dual active protocol stack for the one or more secondary cell group bearers by the user equipment received, provided or transmitted by one of the network nodes according to the third or fourth aspect, e.g. a target MN or a source MN, may comprise information for the user equipment for using a common medium access control entity for the transmitting and/or receiving of the data towards/from the secondary node on the one or more secondary cell group bearers using the first key and for the transmitting and/or receiving of the data towards/from the secondary node on the one or more secondary cell group bearers using the second key.

Further, one or more of the various pieces of information and/or messages exchanged among the UE and the network nodes according to the second to fourth aspect may comprise information indicating that a common MAC entity is to be used, e.g. a parameter, e.g. called “DAPSwith-common-MAC”. Additionally or alternatively, the one or more various pieces of information and/or messages may be indicative of or comprise information indicating that no reconfiguration with synchronization is to be done by the UE.

Thus, in various embodiments, the information relating to the one or more second cell group bearers associated with the secondary node may indicate whether a common medium access control entity is to be used by the user equipment and/or the secondary node for transmitting and/or receiving of data on the one or more secondary cell group bearers using a first key and for transmitting and/or receiving of data on the one or more secondary cell group bearers using a second key. Similarly, in various embodiments, the information relating to the configuration of the dual active protocol stack for the one or more secondary cell group bearers by the user equipment may indicate whether a common medium access control entity is to be used by the user equipment and/or the secondary node for transmitting and/or receiving of data on the one or more secondary cell group bearers using a first key and for transmitting and/or receiving of data on the one or more secondary cell group bearers using a second key. Both may be implemented using a parameter, e.g. “DAPS-with-common-MAC”.

This may for example be the case for information comprised in one or more of: a handover request, a handover request acknowledgement, a SN addition request, a SN addition response and/or a RRC reconfiguration message. By contrast, in various embodiment, the information relating to the one or more second cell group bearers associated with the secondary node comprised in the SN modification response may for example not indicate whether a common MAC entity is to be used, e.g. because at the time the SN modification response is transmitted, it has not yet been determined whether a common MAC entity is to be used.

The SN may e.g. determine based on a SN addition request whether a common MAC entity is to be used by the user equipment. As a result, if the SN has determined that no common MAC entity is to be used, it may know that a random access (e.g. procedure) from the UE to the SN may be expected, required or performed before the second key can be used for transmitting and/or receiving data. On the other hand, if SN has determined that a common MAC entity is to be used, it may know that no random access (e.g. procedure) from the UE to the SN may be expected, required or performed before the second key can be used for transmitting and/or receiving data.

In various embodiments, for instance when no random access (e.g. procedure) from the UE to the SN may be expected, the network node according to the second example aspect, e.g. the SN, may perform the following:
switching from the transmitting of the data towards the secondary node on the one or more secondary cell group bearers using the first key to the transmitting of the data towards the secondary node on the one or more secondary cell group bearers using the second key after the message indicating that the target master node has received the reconfiguration complete message from the user equipment has been received.

The SN may do this for instance after receiving a secondary gNB (SgNB) reconfiguration complete message, e.g. implying that the RA procedure from the UE to the target MN has been completed and/or RRC reconfiguration of the UE, e.g. triggered by an RRC reconfiguration message from the source MN, has been completed.

In various embodiments, for instance when a random access (e.g. procedure) from the UE to the SN may be expected, the network node according to the second example aspect, e.g. the SN, may perform the following:
receiving a random access request from the user equipment; and
starting the transmitting and/or receiving of the data towards/from the secondary node on the one or more secondary cell group bearers using the second key after a random access with the user equipment based on the received random access request has been completed and after the message indicating that the target master node has received the reconfiguration complete message from the user equipment has been received.

Thus, in particular when no common MAC entity is used by the UE, a random access procedure may be performed between the UE and the SN, e.g. after the random access between the UE and the target MN is completed, to establish a connection and/or synchronization between the UE and the SN which is now a SN of the target MN.

Finally, in various embodiments, e.g. regardless of whether a common MAC entity is used or not, the network node according to the second example aspect, e.g. the SN, may perform the following:
transmitting, to the user equipment, a reconfiguration message comprising configuration information relating to a use of a single protocol stack for the one or more secondary cell group bearers; and
receiving, from the user equipment, a reconfiguration complete message.

The reconfiguration message may be or be comprised in an RRC Reconfiguration message. It may be transmitted by the SN e.g. after or once DL and/or UL data transfer with the UE using the second key has been enabled and/or established. In response, the UE may, as described before, reconfigure the one or more SCG bearers with NR DAPS PDCP back to NR PDCP.

Some example embodiments will now be described with reference to the accompanying drawings. It is to be understood, however, that the drawings are designed solely for purposes of illustration and only serve as non-limiting examples. It should be further understood that the drawings are not drawn to scale and that they are merely intended to conceptually illustrate the structures and procedures described herein.

### BRIEF DESCRIPTION OF THE FIGURES

It is shown in:

FIG. 1 a schematic diagram of a system according to an example embodiment;

FIG. 2 a schematic diagram of MCG, SCG and split bearers in a SN and an MN according to an example embodiment;

FIG. 3 a schematic diagram of MCG, SCG and split bearers in a UE according to an example embodiment;

FIG. 4 a schematic diagram illustrating an example sequence of steps when a dual active protocol stack is used for a handover;

FIG. 5 a schematic diagram illustrating example protocol stacks when a dual active protocol stack is used for a handover;

FIG. 6 a schematic diagram illustrating a dual active protocol stack with a common MAC entity according to an embodiment;

FIG. 7 a schematic diagram illustrating an example sequence of steps of an inter-master node handover with a retained primary secondary cell group cell when a dual active protocol stack is used for one or more secondary cell group bearers;

FIG. 8 a schematic block diagram of an apparatus according to an example embodiment of the first, second, third or fourth example aspect;

FIG. 9 a schematic diagram illustrating an example sequence of messages relating to an RRC reconfiguration;

FIG. 10 a flowchart showing steps of an embodiment according to the first example aspect;

FIG. 11 a flowchart showing steps of an embodiment according to the second example aspect;

FIG. 12 a flowchart showing steps of an embodiment according to the third example aspect;

FIG. 13 a flowchart showing steps of an embodiment according to the fourth example aspect.

### DETAILED DESCRIPTION OF EXAMPLE EMBODIMENTS

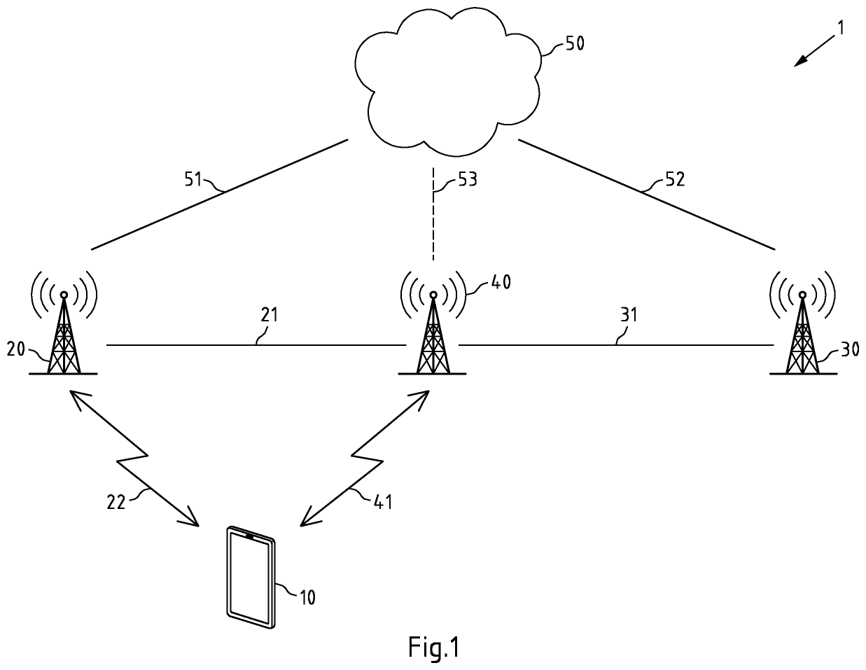

FIG. 1 shows a schematic diagram of a system 1 according to an example embodiment.

The system 1 comprises a UE 10 which may be a UE according to the first example aspect.

The system 1 further comprises a network node 20. Network node 20 may be a network node according to the third example aspect. It may act as a source MN of an inter-MN HO and will therefore be referred to as a source MN 20. It is connected to the UE via communication link 22. Communication link 22 may involve the use of radio resources. It is further connected to the core network 50, e.g. evolved packet core (EPC) or 5G core network (5GC), via connection 51.

The system 1 further comprises a network node 40. Network node 40 may be a network node according to the second example aspect. It may act as a secondary node and will thus be referred to as a secondary node 40. It is connected to the UE via communication link 41. Communication link 41 may involve the use of radio resources. SN 40 has a connection 21 to the source MN 20, e.g. for control plane signalling and coordination. Further, SN 40 may in some cases have a connection 53 to the core network 50, e.g. for transferring user data. However, in other embodiments SN 40 may not have connection 53.

The scenario shown in FIG. 1 may correspond to a multi-radio dual connectivity (MR-DC) scenario, where a multiple Rx/Tx capable UE 10 may be configured to utilise resources provided by two different nodes, e.g. source MN 20 and SN 40, connected via non-ideal backhaul, e.g. connection 21.

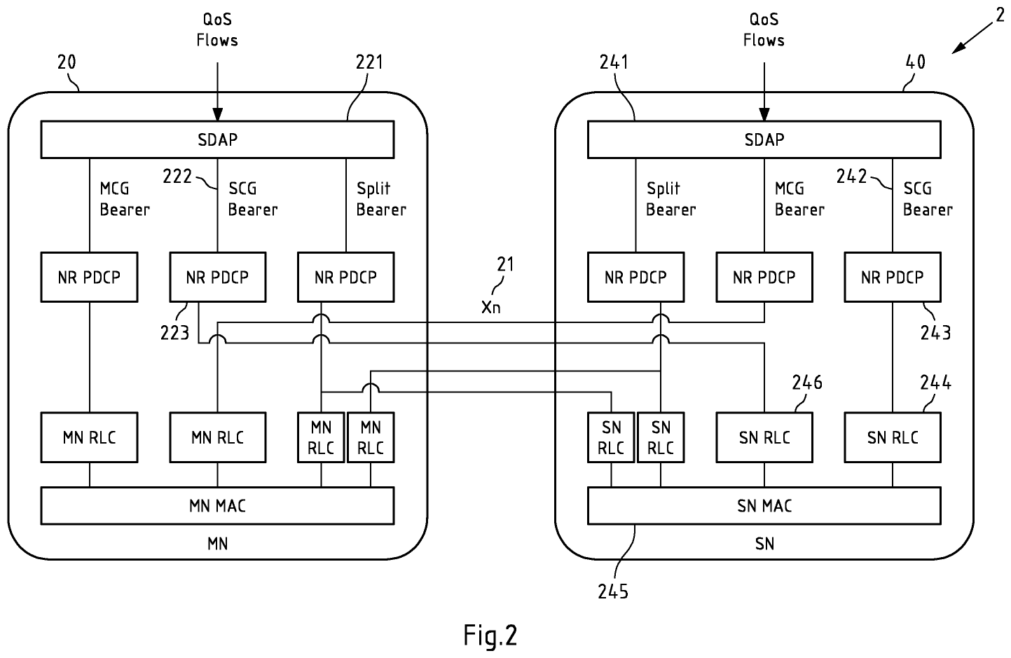

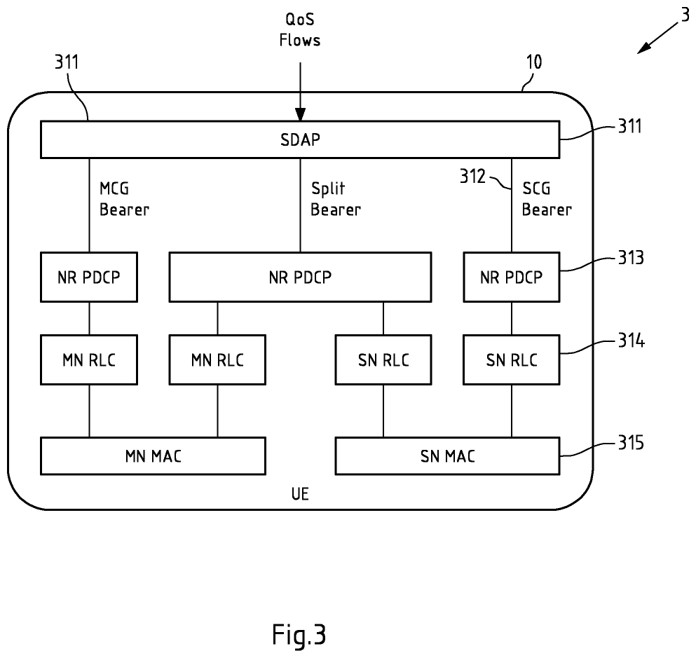

Various radio bearers may be defined for transferring data between the source MN 20, the SN 40 and the UE 10. Examples of such radio bearers will now be explained with reference to FIGS. 2 and 3 before the description of FIG. 1 will be continued.

FIG. 2 shows a schematic diagram 2 of MCG, SCG and split bearers in a SN and a MN according to an example embodiment. In various embodiments, the bearers are radio data bearers, i.e. they may be used for transferring user data.

The schematic diagram 2 shows a MN 20 which may be the source MN 20 described in the context of system 1. It is to be understood that the target MN 30 of system 1 may be configured as shown for MN 20 in FIG. 2.

The schematic diagram 2 further shows a SN 40 which may correspond to the SN 40 of system 1. By way of example, MN 20 and SN 40 are connected by an Xn interface 21. In other embodiments, this may be a different interface, e.g. a X2 interface.

It can be seen that for both, the MN 20 and the SN 40, an MCG bearer, a SCG bearer 222, 242 and a split bearer can be defined, respectively. By way of example, these bearers are positioned in between the SDAP layers 221, 241 and the NR PDCP layers 223, 243, respectively

From a network perspective, each bearer (MCG, SCG 222, 242 and split bearer) can be terminated either in MN 20 or in SN 40. Further, it can be seen that e.g. SCG bearers 222, 242 use radio resources of the SCG. More specifically, it can be seen that the MN 20 terminated SCG bearer 222 is connected to the RLC 246 and, thereby, to the MAC 245 of the SN 40. Similarly, the SN 40 terminated SCG bearer 242 is connected to the RLC 244 and, thereby, to the MAC 245 of the SN 40.

FIG. 3 shows a schematic diagram 3 of MCG, SCG and split bearers in a UE according to an example embodiment.

Similar to what was described for the network side with regard to FIG. 2, the UE 10 has a SCG bearer 312 that is, by way of example, positioned between the SDAP layer 311 and the NR PDCP layer 313. The SCG bearer 312 uses an SN RLC entity 314 and an SN MAC 315 for transferring data.

The description of FIG. 1 will now be resumed.

Setting out from the scenario shown in FIG. 1, source MN 20 may trigger an inter-MN HO to another network node 30. The network node 30 may act as a target MN of the inter-MN HO and will thus be referred to as target MN 30. The target MN 30 may have a connection 31 to the SN 40, e.g. for control plane signalling and coordination, and a connection 52 to the core network. The target MN 30 may have a direct or indirect connection (not shown), e.g. X2/Xn interface, to the MN 20, e.g. for control plane signalling and coordination, and a connection 52 to the core network.

It may be part of the inter-MN HO that the source MN 20 transmits a RRC reconfiguration message to the UE 10. This message might, under various circumstances, include a “reconfiguration with sync” flag, e.g. the field “ReconfWithSync” may be present in the RRCReconfiguration message, e.g. in one or more of the following scenarios
in, e.g. each, configured CellGroupConfig for which the SpCell changes,
in the masterCellGroup:
   at change of AS security key derived from KgNB,
   in an RRCReconfiguration message contained in a DLInformationTransferMRDC message,
in the secondaryCellGroup at:
   PSCell addition,
   SCG resume with NR-DC or (NG)EN-DC,
   update of required SI for PSCell,
   change of AS security key derived from S-KgNB in NR-DC while the UE is configured with at least one radio bearer with keyToUse set to secondary and that is not released by this RRCReconfiguration message,
   MN handover in (NG)EN-DC.

Otherwise, the “ReconfWithSync” field may be optionally present, need M. The field may for example be absent in the masterCellGroup in RRCResume and RRCSetup messages and/or absent in the masterCellGroup in RRCReconfiguration messages if source configuration is not released during DAPS handover. The field being optionally present, need M (Maintain) may mean that the field is a (configuration) field that is stored by the UE i.e. not one-shot Upon receiving a message with the field absent, the UE may maintain the current value.

If reconfiguration with Sync is received at UE for cell group, the case may be considered where the following steps might be executed at UE for the cell-group:
UE may start network synchronization towards the target cell. If target cell information is not provided, UE may re-synchronise to the SSB of source cell followed by reading of MIB and system information.
If DAPS bearers are not configured the MAC may be reset. Further actions following MAC reset such as random access procedure may follow in this case.

As a result of this, due to the reconfiguration with sync at the NR SCG, when the MAC entity is reset and RLC is re-established this may, under various circumstances, cause data interruption time in the given node that has the security key being changed.

This indicates that for MN changes scenarios without change of SCG and if there exists bearer which uses the secondary-cell keys, “ReconfigWithSync” might be included for secondary cell group even if there is no change in SCG configuration (e.g. same PSCell is kept) during this handover.

Thus, when the UE 10 follows the above steps which may be equivalent to SCG cell change scenario, the SCG bearers which uses secondary-cell keys may have interruption for its data transmission until the handover procedure is completed. This might happen even in the case when the same PSCell is retained in the SCG during the handover of the PCell.

Small cells in FR2 may have high system bandwidth which can possibly provide much higher throughput than FR1 macro cells. These cells could e.g. be suitable to serve e.g. XR/cloud gaming/4K streaming services which may use or even require both high throughput and/or high reliability (small interruption time). Therefore, there is a high chance that these services are provided by SCG and as such reducing their interruption during the PCell handover is relevant.

Thus, it may be observed that MN change scenario without modification to SCG (PSCell retained during PCell handover) may, under various circumstances, lead to data interruption for SCG bearers using secondary keys.

In a 3GPP TS 38.331 specification, the corresponding parts might be worded as follows:

### Network Synchronization Part:

1> if the frequencyInfoDL is included:
   2> consider the target SpCell to be one on the SSB frequency indicated by the frequencyInfoDL with a physical cell identity indicated by the physCellId;
1> else:
   2> consider the target SpCell to be one on the SSB frequency of the source SpCell with a physical cell identity indicated by the physCellId;
1> start synchronising to the DL of the target SpCell;
1> apply the specified BCCH configuration defined in 9.1.1.1 for the target SpCell;

### Further:

1> If any DAPS bearer is configured:
   [ . . . ]
1> else:
   2> reset the MAC entity of this cell group;
   2> consider the SCell(s) of this cell group, if configured, that are not included in the SCellToAddModList in the RRCReconfiguration message, to be in deactivated state;
   2> apply the value of the newUE-Identity as the C-RNTI for this cell group;
   2> configure lower layers in accordance with the received spCellConfigCommon;
   2> configure lower layers in accordance with any additional fields, not covered in the previous, if included in the received reconfigurationWithSync.

Operating a DAPS may be considered to contribute to reducing user plane interruption time. It may allow the PDCP to operate over source and target protocol stacks with different security and header compression instances.

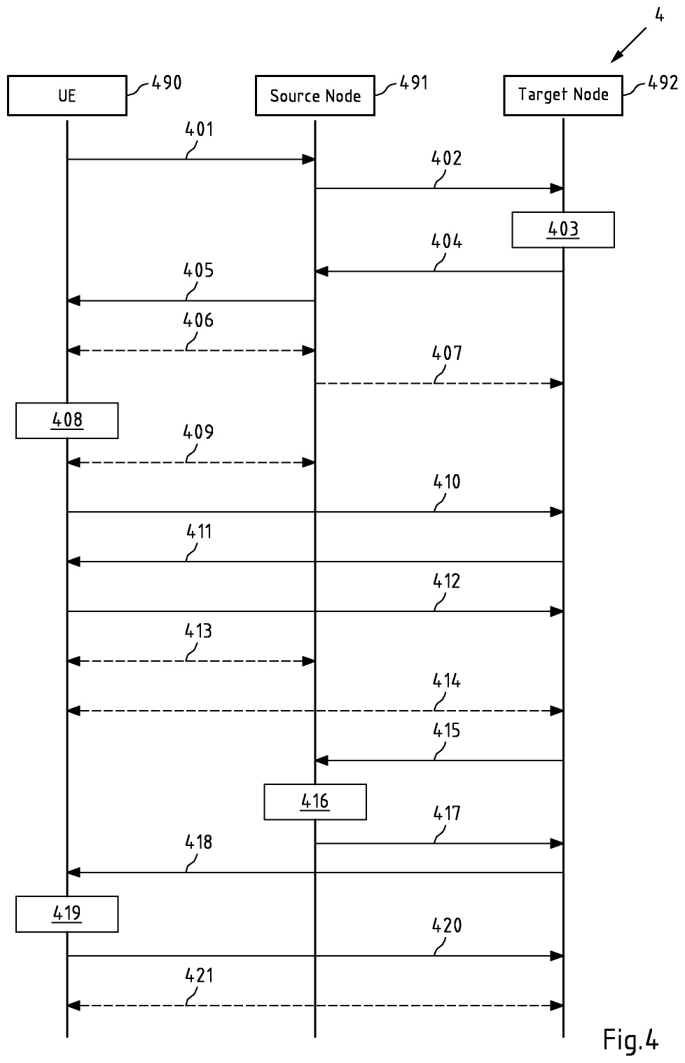

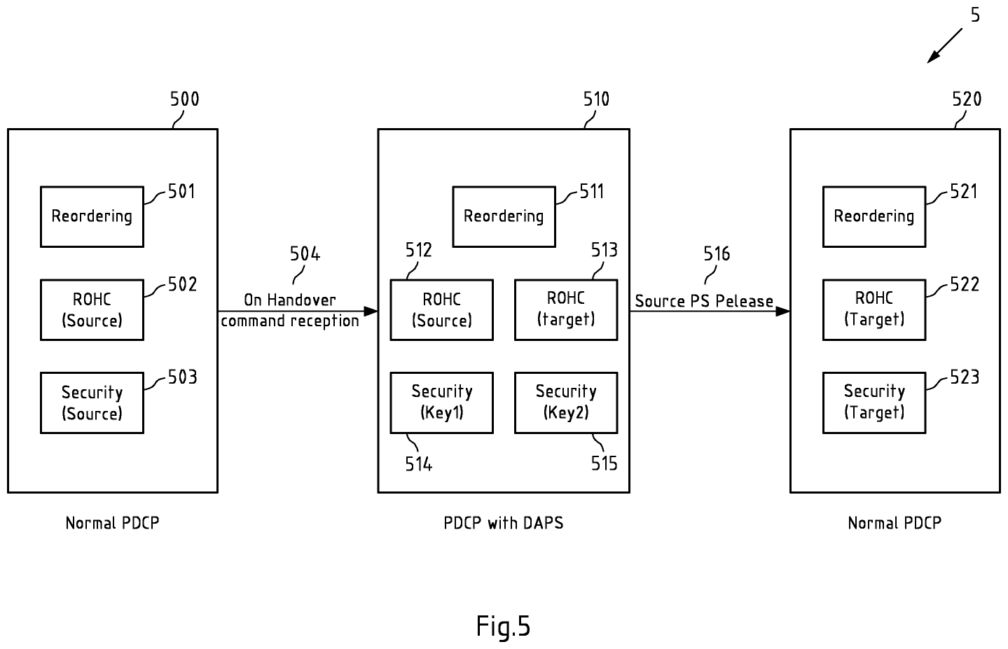

A DAPS operations for a handover will next be described in more detail with reference to FIGS. 4 and 5. A DAPS handover may be understood to be a handover procedure that maintains the source gNB connection after reception of RRC message for handover and until releasing the source cell after successful random access to the target gNB.

It is pointed out that, after the DAPS operation for a handover has been described with reference to FIGS. 4 and 5, it will be described how a DAPS may be used for one or more SCG bearers according to various example embodiments, in particular in scenarios where at least the same PSCell is retained, e.g. “where the SCG configuration remains the same”, during a PCell handover.

In this scenario, various example embodiments may reduce the interruption time on the bearers using SCG.

FIG. 4 shows a schematic diagram 4 illustrating an example sequence of steps when a dual active protocol stack is used for a handover.

The example shown in FIG. 4 relates to a scenario where, when the SN security key refresh happens, the MAC and RLC entities need to be re-established. In addition, in the example of FIG. 4, the PDCP layer is re-established for SN terminated bearers.

FIG. 4 shows actions of a UE 490, a source node 491, also referred to as source cell, and a target node 492, also referred to as target cell, and messages that may be exchanged among them. In particular, the following actions and messages are shown in diagram 4:
401: Measurement Report
402: Handover Request (DAPS)
403: DAPS admission control
404: Handover Request Acknowledgement (DAPS Config)
405: RRC Reconfiguration (DAPS Config)
406: User Data
407: Data Forwarding
408: DAPS operation begins
409: User Data
410: PRACH Preamble
411: RACH Response
412: RRC Reconfiguration Complete
413: User Data
414: User Data
415: HO Success
416: Stop TX/RX to/from UE
417: SN Status Transfer
418: RRC Reconfiguration (source PS release)
419: Release source configuration
420: RRC Reconfiguration Complete
421: User Data

During the DAPS handover execution shown in diagram 4, UE 490 communicates with source and target PCell 491, 492, respectively. So in the given example, the source SCG needs to be released by the source PCell 491 before sending DAPS handover command.

RRC reconfiguration may be required to release the source Protocol Stack as shown in step 418 followed by the UE 490 releasing action in step 419.

In the given example, a new RRC reconfiguration message may then be required to add SCell(s) to target PCell 492 after releasing the source PS or may be combined with the source PS release message 418 (which may be the earliest time to add any SCells following DAPS HO).

FIG. 5 shows a schematic diagram illustrating example protocol stacks when a dual active protocol stack is used for a handover. More specifically, it shows the PDCP configuration at the UE 490 for the example scenario illustrated in FIG. 4.

Block 500 shows the PDCP configuration before the DAPS handover is triggered. Block 500 comprises one reordering entity 501, one ROHC entity 502 relating to the source node 491 and one security entity 503 also relating to the source node 491.

On handover command reception 504, e.g. when the RRC Reconfiguration message is received in step 405 in FIG. 4, the UE 492 may establish a DAPS for the handover.

Block 510 shows the PDCP configuration during the DAPS handover. Block 510 still comprises one reordering entity 511. It also still comprises one ROHC entity 512 relating to the source node 491 and one security entity 514 with a first key which relates to the source node 492. However, as compared to the PDCP configuration before the DAPS was initiated (block 500), the PDCP now additionally comprises a ROHC entity 513 relating to a target node 492 and a security entity 515 with a first key relating to the target node 492.

The protocol stack relating to the source node 491 could then be released in step 516. This could, for example, be done as shown by message 418 in FIG. 4.

Block 520 shows the PDCP configuration after the DAPS handover is completed. Block 520 comprises one reordering entity 521, one ROHC entity 522 relating to the target node 492 and one security entity 523 also relating to the target node 492.

Overall, it can be seen that as an intermediate step, a dual active protocol stack can be used to host ROHC and security entities 512, 513, 514, 515 that relate to two different nodes 491, 492, i.e. two active protocol stacks. Before and after the intermediate step, a single protocol stack may be used, as shown in blocks 500 and 520.

It is to be understood that blocks 502 and 512 may refer to a same entity. Similarly, Blocks 503 and 514 may refer to a same entity (different from the ones of blocks 502 and 512). Again similarly, blocks 513 and 522 may refer to a same entity and 515 and 523 may refer to a same entity. Finally, also blocks 501, 511 and 521 may refer to a same entity. The different reference numerals were merely chosen to simplify the referencing to the single blocks.

After the DAPS operation for a handover has been described with reference to FIGS. 4 and 5, it will now be described how a DAPS may be used for one or more SCG bearers according to various example embodiments. The various example embodiments may, under various circumstances, contribute to reducing the interruption time on bearers using SCG radio resources during inter-MN handover with same SCG configuration where the PSCell is retained during the handover.

Two types of embodiments may be distinguished. The first type of embodiments relates to the use of a DAPS with a common MAC entity whereas the second type does not.

First, an example embodiment that relates to the use of a DAPS with a common MAC entity will be described. By way of example, the embodiment relates to handover scenarios involving SN maintained cases.

When MN sends RRC-Reconfiguration message with ReconfigurationWithSync or ReconfWithSync for master cell group which also indicates change of master key, MN includes DAPS-Config for selected SCG bearers for which interruption free handover is required and includes the SCG configuration without ReconfigurationWithSync. The DAPS-Config contains the configuration to establish a DAPS PDCP for selected SCG bearers hosting two security layers for ciphering and integrity protection: First layer is using a first SN key derived from source MN key and second layer using a second SN key derived from the target MN key. Within the DAPS-Config.

MN may include new parameter DAPS-with-common-MAC as the same PSCell is retained during the handover.

Upon receiving the RRC reconfiguration, UE may configure DAPS PDCP for the selected SCG bearers without resetting MAC based on the SCG configuration without ReconfigurationWithSync.

After receiving the RRC reconfiguration, UE continues to receive user packets for the selected SCG bearers using the first SN key and the “old” C-RNTI (used to communicate with the UE before the handover is triggered), e.g. as long as the handover execution/random access (e.g. procedure) is not completed to the target MN.

After successful target MN RACH access (e.g. procedure) and sending RRC Reconfiguration Complete to the target MN, UE stops sending new packets for the selected SCG bearers using the first SN key and switches to the second key and applies the new C-RNTI, i.e., new UL packets are encrypted with second key.

On the network side, the source SN will start using the second key (and new C-RNTI) for the UE upon receiving a message from the MN that the random access and reconfiguration of the target MN is completed successfully.

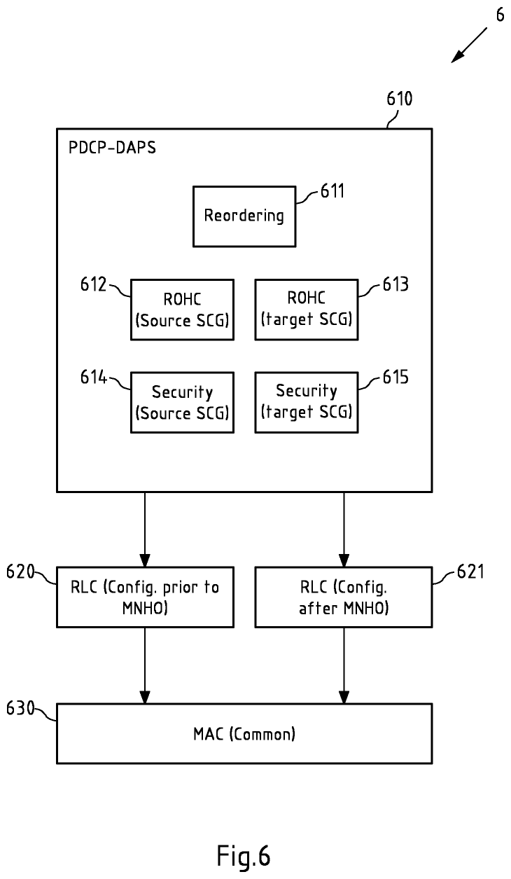

DAPS with common MAC is DAPS behaviour where the UE needs not necessarily have two simultaneous TX/RX physical layer operations and MAC may remain common between source and target SCG PS. It may be considered to be a modified DAPS behaviour as compared to the DAPS behaviour explained with reference to FIGS. 4 and 5. Only RLC and PDCP aspects of DAPS may be considered to be equally applicable. The modified DAPS behaviour will now be explained in more detail with reference to FIG. 6.

FIG. 6 shows a schematic diagram 6 illustrating a dual active protocol stack with a common MAC entity according to an embodiment. More specifically, FIG. 6 shows a modified PDCP-DAPS operation on the SCG-bearers for SN-maintained handover scenario according to an embodiment, in particular an embodiment using a DAPS with a common MAC entity.

Similar to the PDCP of block 510 described with reference to FIG. 5, the PDCP-DAPS 610 comprises one reordering entity 611 but two ROHC and security entities. However, while in block 510 one ROHC entity 512 and one security entity 514 relate to a source node and one ROHC entity 513 and one security entity 515 relate to a target node, in the PDCP-DAPS 610 one ROHC entity 612 and one security entity 614 relate to a source SCG, and one ROHC entity 613 and one security entity 615 relate to a target SCG.

FIG. 6 further shows two RLC entities 620, 621. The first RLC entity 620 relates to a configuration prior to the master node handover (MNHO) whereas the second RLC entity 621 relates to a configuration after the MNHO.

Finally, FIG. 6 shows that the DAPS-PDCP 610 and the two RLC entities 620, 621 make use of a common MAC entity 630.

Thus, UL and DL data transmission may happen on the same MAC entity 630 without it having to undergo a re-establishment with the RLC bearers mapped on it. The UL and DL data using both old key (Key 1), e.g. provided by the PDCP-DAPS 610 and, more specifically, by the security entity 614, and new key (Key 2), e.g. provided by the PDCP-DAPS 610 and, more specifically by the security entity 615, use the same MAC entity 630 until the random access to the target MN (and to target SN in case of embodiments without a common MAC entity) is completed where the UE discontinues usage of old key and the associated L2 entities. With this approach, even though the MN key changes the mandatory SN key change does not interrupt the flow of the data passing through the SN as there is no reset and re-establishment of the MAC/RLC/PDCP layers.

In various embodiments, in all the above steps, the UE may use (e.g. only) single physical layer operation on SCG with common MAC.

Now, an example embodiment that relates to the use of a DAPS without a common MAC entity will be described. By way of example, the embodiment relates to handover scenarios involving SN maintained cases.

In this embodiment, RRC Reconfiguration (containing or comprising ReconfigWithSync) can be sent for secondary-cell group but with DAPS configured for SCG. In this case the target SCG configuration may be activated after successful random access completion at MCG and target SCG.

Upon receiving the RRC Reconfiguration, the UE configures for the selected SCG bearers DAPS PDCP hosting two security layers for ciphering and integrity protection: First layer is using a first SN key derived from source MN key and second layer using a second SN key derived from the target MN key.

After receiving the RRC reconfiguration, UE continues to receive user packets for the selected SCG bearers using the first SN key and the old C-RNTI (used to communicate with the UE before the handover is triggered) as long as the handover execution/random access is not completed to the target MN and SN.

After the successful random access to the target MN and target SN is completed, the UE starts to send/receive UL/DL for the selected SCG bearers using the first and second keys simultaneously.

Depending on UE capability, either an embodiment relating to a DAPS with a common MAC or an embodiment relating to a DAPS without a common MAC can be activated.

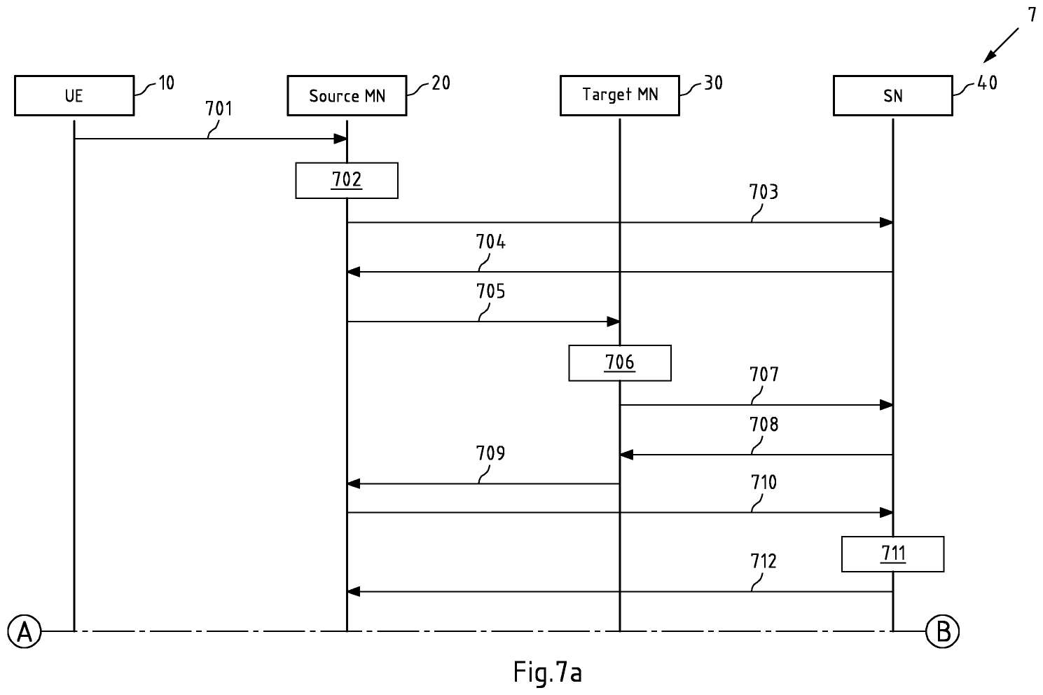

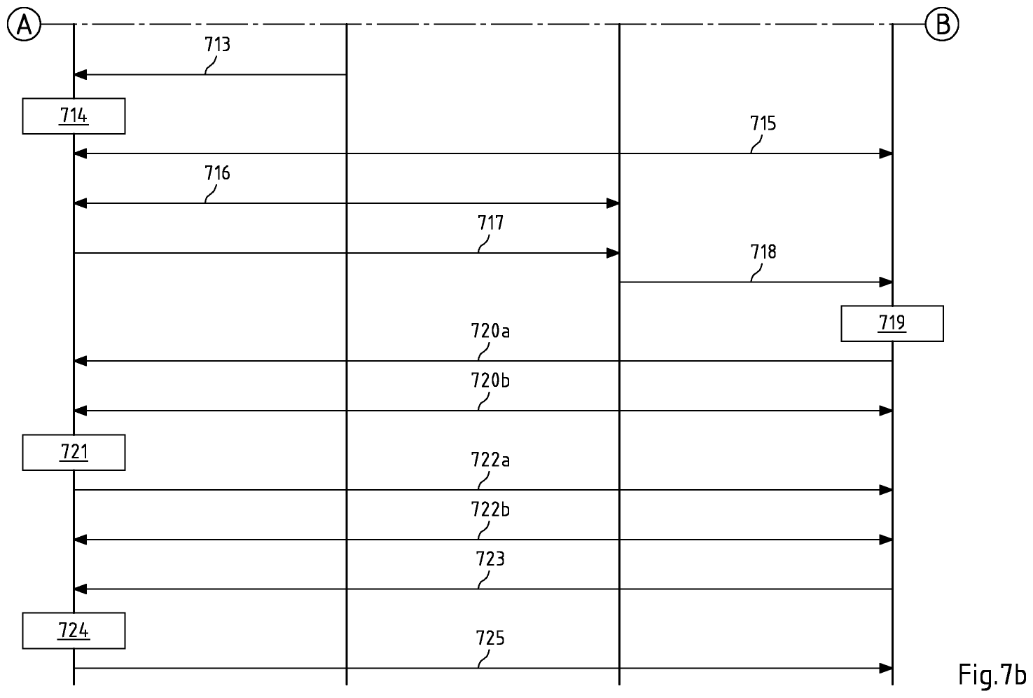

FIG. 7, consisting of FIG. 7a which is continued in FIG. 7b, shows a schematic diagram 7 illustrating an example sequence of steps of an inter-master node handover with a retained primary secondary cell group cell when a dual active protocol stack is used for one or more secondary cell group bearers.

Two example embodiments will now be described with reference to FIG. 7.

The first embodiment relates to a DAPS with a common MAC. The steps, actions and messages shown in FIG. 7 may be as follows for the first embodiment:
701: Measurement Report
702: Trigger MN HO
703: SN Modification Request
704: SN Modification Response
   (SCG-Config, SCG-RB-Config)
705: Handover Request
   (SCG-Config (+w/o reconfWithSync), SCG-RB-Config-DAPS (+MAC-retain))
706: Decision to maintain SN; ask SN to retain MAC and prepare DAPS config without a reconfiguration with Sync
707: SN Addition Request (SCG-Config (+w/o reconfWithSync), SCG-RB-Config-DAPS (+MAC-retain))
708: SN Addition Response (SCG-Config (w/o reconfWithSync), SCG-RB-Config-DAPS-MAC-retain)
709: Handover RequestAck
   (HO container (MCG config+SCG-Config (w/o reconfWithSync), SCG-RB-Config-DAPS (+MAC retained)))
710: SN Release Request
711: Forwarding for non-DAPS bearers
712: SN Release Response
713: RRC Reconfiguration
   (HO container (MCG config+SCG-Config (w/o reconfWithSync), SCG-RB-Config-DAPS (+MAC retained)))
714: Reconfigure bearers with NR DAPS to NR PDCP DAPS without MAC reset
715: UL/DL data transfer with DAPS PDCP (using old key)
716: RA procedure
717: RRC Reconfiguration Complete
718: SgNB Reconfiguration Complete
719: Start DL with new C-RNTI, new key
720a: DL data transfer with DAPS PDCP (using new key)
720b: (not present in this embodiment; may be relevant for other embodiments)
721: Switch to DAPS PDCP entity (using C-RNTI, new key)
722a: UL data transfer with DAPS PDCP (using new key)
722b: (not present in this embodiment; may be relevant for other embodiments)
723: RRC Reconfiguration (source PS release (adapted for SCG))
724: Reconfigure bearers with NR DAPS PDCP back to NR PDCP
725: RRC Reconfiguration Complete

The single example steps will now be described in more detail.

Steps 701-704: Upon triggering a HO, source MN 20 fetches the SCG configuration from the source SN 40. The SN 40 informs the MN 20 that it has some bearers which can benefit from DAPS feature, e.g, XR bearers for instance (indicating inside the SCG RB configuration). The source MN 20 informs the target MN 30 to prepare the DAPS configuration for these SCG bearers. When target MN 30 retains the same SN 40 it will prepare the DAPS configuration for these SCG bearers.

Step 705: The target MN 30 is requested in step 705 to prepare the SN 40 to provide a SCG configuration without the “reconfiguration with sync” and also to provide the DAPS configuration for selected SN bearers ensuring that the SCG MAC is retained (i.e. no reset of the MAC which implies no random access is initiated by the MAC).

Step 706-708: The SN 40 understands that the target MN 30 would want to retain the SCG and also want a DAPS compatible SCG configuration as stated in the description of Step 705. The target MN 30 asks the SN 40 to provide a DAPS configuration with common MAC for each of the bearers that can benefit from the reduced and/or zero data interruption. This may further require the SN 40 to provide the NR RRC reconfiguration container to the MN without setting the “reconfWithSync” flag in the RRC message 713 to the UE and provide a DAPS configuration for the bearers which retain the same MAC at the SCG.

Step 709: The HO request acknowledge contains the SN side configuration with the DAPS configuration. The MN 30 adds an MCG part of the configuration comprising of the target MN 30 configuration in HO container.

Step 710, 712: The source MN 20 releases the SN 40 from its side (as this is now added by the target MN 30). These steps do not impact SCG DAPS bearers and needed for other bearers or forwarding for split bearers.

Step 713: The UE 10 receives the RRC reconfiguration and implements the following behavior: To take the new SN key into account, the MAC entity of the SCG does not undergo a MAC reset i.e. the MAC entity is only reconfigured as the “reconfiguration with sync” indication in the NR RRC message is not set. As a consequence, the RLC entities associated at the SCG are not required to be re-established.

Step 714: The UE 10 reconfigures the SCG bearers with the DAPS configuration provided i.e. there are two PDCP entities per DAPS bearer which handle the data corresponding to the old SN and new SN keys respectively. This makes the DAPS operation to begin at the SCG side.

Step 715: UL/DL data transfer continues with the old SN key.

Step 716-717: UE 10 performs RA procedure with target MN 30. Upon successful completion of Step 716, e.g. at the minimum, the UE 10 lower layer indicates to the DAPS PDCP entity within the UE 10 about this event.

Then, e.g. any time after step 717, data transmission/receipt between target MN and UE can take place.

Step 718: The target MN 30 indicates the successful SN side configuration.

Step 719: The SN 40 uses Step 718 as a trigger to start DL transmission to the UE 10 with the new C-RNTI and new key. The UE 10 is by this time possibly monitoring old and new C-RNTI. Upon receiving DL data on new C-RNTI it can start UL transmission with new C-RNTI completing the switch to the SCG.

Step 720-722: The UE 10 switches the transmit entity of the NR DAPS PDCP to start using the new key due to the trigger described in Step 716-717. User data transmission continues in the UL/DL with the new key as the SN 40 starts DL transmission with the new key in Step 720.

Step 723: The source PS is released by means of RRC Reconfiguration i.e. the protocol stack part which was using the old key.

Step 724-725: DAPS operation of the SCG is terminated as the UE 10 reconfigures the NR DAPS PDCP back to NR PDCP. The UE 10 indicates successful completion of Step 723 and/or Step 724 by the reconfiguration complete in Step 725.

It may be noted that, as there is no reconfiguration with sync during the key change procedure and instead DAPS is used to meet small interruption requirement for some bearers in the embodiment described above, it may not be necessary that the UE 10 performs a random access to the SN 40 for the key change.

The second embodiment relating to a DAPS without a common MAC will now be described with reference to FIG. 7. The steps, actions and messages shown in FIG. 7 for the second embodiment are as follows:
701: Measurement Report
702: Trigger MN HO
703: SN Modification Request
704: SN Modification Response
   (SCG-Config, SCG-RB-Config)
705: Handover Request
   (SCG-Config (+ with reconfWithSync), SCG-RB-Config-DAPS)
706: Decision to maintain SN; ask SN to prepare DAPS config
707: SN Addition Request
   (SCG-Config (+ with reconfWithSync), SCG-RB-Config-DAPS)
708: SN Addition Response
   (SCG-Config (with reconfWithSync), SCG-RB-Config-DAPS)
709: Handover RequestAck
   (HO container (MCG config+SCG-Config with SCG-RB-Config-DAPS))
710: SN Release Request
711: Forwarding for non-DAPS bearers
712: SN Release Response
713: RRC Reconfiguration
   (HO container (MCG config+SCG-Config, SCG-RB-Config-DAPS))
714: Reconfigure bearers with NR DAPS to NR PDCP DAPS
715: UL/DL data transfer with DAPS PDCP (using old key)
716: RA procedure (MCG)
717: RRC Reconfiguration Complete
718: SgNB Reconfiguration Complete
719: (not present in this embodiment; may be relevant for other embodiments)
720a: (not present in this embodiment; may be relevant for other embodiments)
720b: RA procedure (SCG)
721: Start DAPS PDCP entity (using new key)
722a: (not present in this embodiment; may be relevant for other embodiments)
722b: UL/DL data transfer with old and new key in DAPS mode
723: RRC Reconfiguration (source PS release (adapted for SCG)—MN involved)
724: Reconfigure bearers with NR DAPS PDCP back to NR PDCP
725: RRC Reconfiguration Complete

As can be seen, various steps are different as compared to the first embodiment described with reference to FIG. 7. In other embodiments, further steps may be different. Accordingly, it is to be understood that steps shown in FIG. 7 cannot only be used together with some or all other steps used in FIG. 7, but also on their own.

The second embodiment is an alternative to the embodiment 1 described above, but allows a reconfiguration with sync with a DAPS configuration sent to the UE 10 in Step 709/713. The SN 40 prepares a DAPS configuration with a SCG configuration that allows the UE 10 to transmit data using old and new key simultaneously using the DAPS configuration. However, the main difference to the first embodiment 1 is that the UE 10 applies the DAPS configuration at Step 713 upon reception of the RRC reconfiguration but waits until the random access is completed to MCG (i.e. at Step 716) and SCG (at step 720b) to start transmitting/receiving in UL/DL using both old and new keys simultaneously (instead of switching the keys as in the first embodiment). The source PS release (adapted for SCG) indicates to the UE 10 to release the source side of the SCG stack that was configured for DAPS. At Step 724, the UE reconfigures back the SCG to single PS operation.

One or more embodiments or parts thereof may be anchored in specifications, e.g. in 3GPP stage 2 TS 37.340 by introducing a message sequence with DAPS for SCG. Further, the 3GPP Stage 3 RRC TS 38.331 specification may update the field description “reconfiguration with sync” with a condition that when DAPS bearer configuration is performed at the SCG the flag will not be set by the network. In addition, procedural description for RRC reconfiguration may cover the case for NR SCG that describes DAPS bearer handling in the realm when SCG is maintained during the LTE/NR HO.

Under various circumstances, the embodiments described above may have the following advantages. The key change when the SN 40 is maintained (PSCell is not changed) may be done with reduced or even without any reset/re-establishment of the MAC/RLC/PDCP layers. Further, there may be reduced, e.g. even zero, user data interruption time for SCG bearer traffic, e.g. during the above mobility scenarios.

Additionally, the following aspects relating to embodiments of the first type (“DAPS with common MAC entity”) and of the second type may be highlighted.

For reconfiguration with sync sent for the secondary cell group where source and target PScell are same for key change purpose, SCG may use ‘optimised’ DAPS behaviour to reduce interruption. In embodiments of the first type, a new DAPS model with common MAC is introduced to avoid any MAC reset as part of this procedure. In embodiments of the second type, the target MCG is, in various embodiments, not required to be suspended during DAPS as source and target PScell of DAPS are same.

In embodiments of both types, it may be that target MCG is not suspended and that DAPS is configured for SCG. The difference is that random access to target SCG may be skipped in embodiments of the first type (and UE 10 may do a hard switch of the security keys) and in embodiments of the second type the random access to target SCG is performed (and UE 10 transmit/receive with SCG using the old and new keys).

In existing specification (for DAPS HO standardized in Rel-16) uplink switching of DAPS operation is based on reception of first uplink grant from target cell. For dual connectivity scenario for SCG-DAPS where RACH is not required, the uplink switching may now be based on UE 10 completing RACH procedure with MCG. This may require an indication from MCG component and RACH success to SCG-DAPS layer within UE 10. After this switching of uplink, the actual transmission using target PDCP starts only when SN sends PDCCH with new C-RNTI.

Thus, various embodiments relate to a DAPS model with common MAC and/or modified uplink switching based on MCG-success and PDCCH (new RNTI).

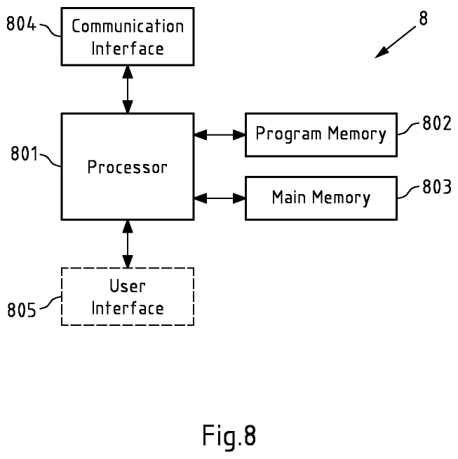

FIG. 8 shows a schematic block diagram of an apparatus 8 according to an example embodiment of the first or second example aspect. The apparatus 8 may be a UE or a network node, e.g. a network node acting as a secondary node, a source master node or a target master node of an inter-MN handover.

Apparatus 8 comprises a processor 801, a program memory 802, a main memory 803, a communication interface 804, and optionally user interface 805, in particular when the apparatus 8 is a UE. In various embodiments, the apparatus 8 comprises further units, parts or structural and/or functional elements.

Apparatus 8 may for instance be configured to perform and/or control or comprise respective means (at least one of 801 to 805) for performing and/or controlling and/or configured to perform the method according to one or more example aspects. Apparatus 8 may as well be an apparatus comprising at least one processor 801 and at least one memory 803 including computer program code, the at least one memory 803 and the computer program code configured to, with the at least one processor 801, cause an apparatus, e.g. apparatus 8 at least to perform and/or control the method according to one or more example aspects.

Processor 801 may for instance further control the memories 802, 803, the communication interface 805, and the optional user interface 805.

Furthermore, processor 801 may for instance execute computer program code stored in program memory 802, which may for instance represent a computer readable storage medium comprising program code that, when executed by processor 801, causes the processor 801 to perform the method according to one or more example aspects.

Processor 801 (and also any other processor mentioned in this specification) may be a processor of any suitable type. Processor 801 may comprise but is not limited to one or more microprocessor(s), one or more processor(s) with accompanying one or more digital signal processor(s), one or more processor(s) without accompanying digital signal processor(s), one or more special-purpose computer chips, one or more field-programmable gate array(s) (FPGA(s)), one or more controller(s), one or more application-specific integrated circuit(s) (ASIC(s)), or one or more computer(s). The relevant structure/hardware may be programmed in such a way to carry out the described function. Processor 801 may for instance be an application processor that runs an operating system.

Program memory 802 may also be separate from or included in processor 801. This memory may for instance be fixedly connected to processor 801, or be at least partially removable from processor 801, for instance in the form of a memory card or stick. Program memory 802 may for instance be non-volatile memory. It may for instance be a FLASH memory (or a part thereof), any of a ROM, PROM, EPROM and EEPROM memory (or a part thereof) or a hard disc (or a part thereof), to name but a few examples. Program memory 802 may also comprise an operating system for processor 801. Program memory 802 may also comprise a firmware for apparatus 8.

Apparatus 8 comprises a working memory 803, for instance in the form of a volatile memory. It may for instance be a Random Access Memory (RAM) or Dynamic RAM (DRAM), to give but a few non-limiting examples. It may for instance be used by processor 801 when executing an operating system and/or computer program.

The communication interfaces 804 may enable the apparatus 8 to communicate with other entities. The communication interfaces 804 may for instance comprise a wireless interface, e.g. a cellular radio communication interface and/or a WLAN interface and/or a wire-bound interface, e.g. an IP-based interface, for instance to communicate with entities via the Internet.

User interface 805 is optional and may comprise a display for displaying information to a user and/or an input device (e.g. a keyboard, keypad, touchpad, mouse, etc.) for receiving information from a user.

Some or all of the components of the apparatus 8 may for instance be connected via a bus. Some or all of the components of the apparatus 8 may for instance be combined into one or more modules.

In the following, some aspects relating to various embodiments will be summarized.

Various embodiments relate to reducing the interruption time on the bearers which use SCG resources. This may happen during inter-MN handover where SCG/PSCell is retained. DAPS may be used in this context.

Further, the use of DAPS for SCG during inter-MN could be one of the potential options, if the data exchange with SN is to be continued during inter-MN handover (in the legacy standard there is a gap in data exchange via SCG, even though it is the MCG is changed). One might consider that this came at the expense of complexity.

However, DAPS was standardized for PCell HO interruption reduction time already in Rel-16 and it may nevertheless be considered to be beneficial to extend DAPS operation for CA and DC specific scenarios. Accordingly, there is potential for DAPS based implementations possible in near future for interruption time reduction. Moreover, this may be considered to only be a base solution for interruption reduction and any enhancements for the same. Embodiments of the first type use a common MAC without actual Dual TX/RX requirement at the lower layers which is attractive as this, under various circumstances, may avoid requiring triple connectivity for the DAPS operation at the SCG (for interruption time reduction). This may reduce the DAPS specific complexity to significant extent and may neatly interwork with dual connectivity by ensuring that MCG transmission continues without requiring any suspension and SCG transmission interruption time is reduced.

Moreover, it is noted that various embodiments may be superior over approaches that require suspension of MCG during DAPS handover for SCG for PS-Cell change scenario because in various scenarios, UE cannot support 3 active links simultaneously. This requires additional capability and will not be attractive or feasible, e.g. in the Rel-18, as 3 Rx and Tx requirement requires additional hardware on the UE side. Various embodiments described above do not require MCG suspension as the source and target cells are same. Further, embodiments of the first type propose the concept of ‘common MAC’. In addition, the UL switching point in DAPS standardized for Rel-16 is adapted uniquely for SCG by redefining it for dual connectivity and linking the same with the PCell random access.

Further, it might be wondered whether there are PDCP changes and security issues the above described embodiments cause.

As to this, in particular the usage of the monitoring of C-RNTI for the new configuration mapped in embodiments of the second type cover the aspects from UE how the monitoring and setting up of the protocol stack components with the old and new keys are managed. Thus, those aspects are covered by various embodiments.

Apart from that, it may be wondered whether future work, e.g. in Rel-18, should predominantly focus on MCG/PCell mobility, done using DAPS and possibly combined with DC.

However, various embodiments fit into the use case of how to avoid or reduce interruption time in the SCG when there is a reconfiguration with sync (forcing interruption) which is a frequently happening scenario in practical deployments. As stated before, services like XR/AR, cloud gaming and 4K streaming services are likely to be deployed on SN since they offer large transmission bandwidth. As these services have also strict outage requirements, solutions for reducing the interruption time on SN is a relevant topic.

In the above description, several example embodiments were described, inter alia with regard to a DAPS in the context of a handover. Further, RRC configurations were discussed. Some more details on several related aspects will now be provided.

First, more details with regard to mobility in RRC_CONNECTED are given, as described in section 9.2.3 of TS38.300. These details relate in particular to the description given with reference to FIGS. 4 and 5.

For DAPS handover:

A DAPS handover can be used for an RLC-AM or RLC-UM bearer. For a DRB configured with DAPS, the following principles are additionally applied.

### Downlink:

During HO preparation, a forwarding tunnel is always established.
The source gNB is responsible for allocating downlink PDCP SNs until the SN assignment is handed over to the target gNB and data forwarding in 9.2.3.2.3 takes place.

That is, the source gNB does not stop assigning PDCP SNs to downlink packets until it receives the HANDOVER SUCCESS message and sends the SN STATUS TRANSFER message to the target gNB.
Upon allocation of downlink PDCP SNs by the source gNB, it starts scheduling downlink data on the source radio link and also starts forwarding downlink PDCP SDUs along with assigned PDCP SNs to the target gNB.
For security synchronisation, HFN is maintained for the forwarded downlink SDUs with PDCP SNs assigned by the source gNB. The source gNB sends the EARLY STATUS TRANSFER message to convey the DL COUNT value, indicating PDCP SN and HFN of the first PDCP SDU that the source gNB forwards to the target gNB.
HFN and PDCP SN are maintained after the SN assignment is handed over to the target gNB. The SN STATUS TRANSFER message indicates the next DL PDCP SN to allocate to a packet which does not have a PDCP sequence number yet, even for RLC-UM.
During handover execution period, the source and target gNBs separately perform ROHC header compression, ciphering, and adding PDCP header.
During handover execution period, the UE continues to receive downlink data from both source and target gNBs until the source gNB connection is released by an explicit release command from the target gNB.
During handover execution period, the UE PDCP entity configured with DAPS maintains separate security and ROHC header decompression functions associated with each gNB, while maintaining common functions for reordering, duplicate detection and discard, and PDCP SDUs in-sequence delivery to upper layers. PDCP SN continuity is supported for both RLC AM and UM DRBs configured with DAPS.

### Uplink:

The UE transmits UL data to the source gNB until the random access procedure toward the target gNB has been successfully completed. Afterwards the UE switches its UL data transmission to the target gNB.
Even after switching its UL data transmissions towards the target gNB, the UE continues to send UL layer 1 CSI feedback, HARQ feedback, layer 2 RLC feedback, ROHC feedback, HARQ data (re-)transmissions, and RLC data (re-)transmissions to the source gNB.
During handover execution period, the UE maintains separate security context and ROHC header compressor context for uplink transmissions towards the source and target gNBs. The UE maintains common UL PDCP SN allocation. PDCP SN continuity is supported for both RLC AM and UM DRBs configured with DAPS.
During handover execution period, the source and target gNBs maintain their own security and ROHC header decompressor contexts to process UL data received from the UE.
The establishment of a forwarding tunnel is optional.
HFN and PDCP SN are maintained in the target gNB. The SN STATUS TRANSFER message indicates the COUNT of the first missing PDCP SDU that the target should start delivering to the 5GC, even for RLC-UM.

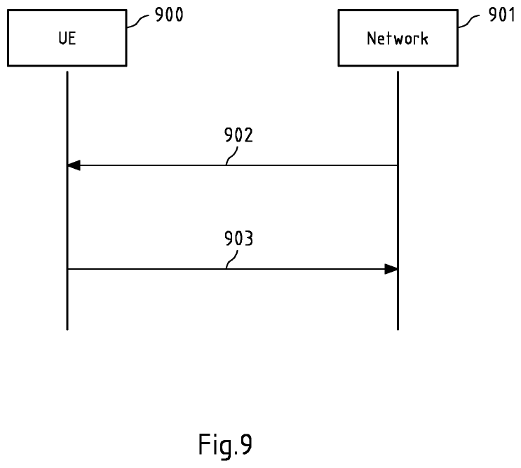

Next, more details with regard to RRC reconfiguration are given with reference to FIG. 9.

FIG. 9 shows a schematic diagram 9 illustrating an example sequence of messages relating to an RRC reconfiguration.

FIG. 9 shows how, first, network 901 transmits a RRC Reconfiguration message 902 to UE 900.

UE 900 will respond to this by a message 903. In case of a successful RRC reconfiguration, message 903 is a RRC Reconfiguration Complete message. In case of a failure, message 903 is a RRC Connection Re-establishment message.

The following is described in section 5.3.5 of 3GPP TS38.331 with regard to the RRC reconfiguration.

The purpose of this procedure is to modify an RRC connection, e.g. to establish/modify/release RBs/BH RLC channels, to perform reconfiguration with sync, to setup/modify/release measurements, to add/modify/release SCells and cell groups, to add/modify/release conditional handover configuration, to add/modify/release conditional PSCell change configuration. As part of the procedure, NAS dedicated information may be transferred from the Network to the UE.

RRC reconfiguration to perform reconfiguration with sync includes, but is not limited to, the following cases:
reconfiguration with sync and security key refresh, involving RA to the PCell/PSCell, MAC reset, refresh of security and re-establishment of RLC and PDCP triggered by explicit L2 indicators;
reconfiguration with sync but without security key refresh, involving RA to the PCell/PSCell, MAC reset and RLC re-establishment and PDCP data recovery (for AM DRB) triggered by explicit L2 indicators.
reconfiguration with sync for DAPS and security key refresh, involving RA to the target PCell, establishment of target MAC, and
   for non-DAPS bearer: refresh of security and re-establishment of RLC and PDCP triggered by explicit L2 indicators;
   for DAPS bearer: establishment of RLC for the target PCell, refresh of security and reconfiguration of PDCP to add the ciphering function, the integrity protection function and ROHC function of the target PCell;
   for SRB: refresh of security and establishment of RLC and PDCP for the target PCell;
reconfiguration with sync for DAPS but without security key refresh, involving RA to the target PCell, establishment of target MAC, and:
   for non-DAPS bearer: RLC re-establishment and PDCP data recovery (for AM DRB) triggered by explicit L2 indicators.
   for DAPS bearer: establishment of RLC for target PCell, reconfiguration of PDCP to add the ciphering function, the integrity protection function and ROHC function of the target PCell;
   for SRB: establishment of RLC and PDCP for the target PCell.

If e.g. an embodiment described above relating to a DAPS using a common MAC is implemented, the above description with regard to the RRC reconfiguration could be modified by one or more of the following amendments and additions:

RRC reconfiguration to perform reconfiguration within PCell/PSCell (and without sync) includes, but is not limited to, the following cases:
reconfiguration (without sync) and with security key refresh, retain/maintain/sustain (common) MAC, refresh of security and establishment of second RLC and second part of PDCP triggered by explicit L2 indicators;
[ . . . ]
reconfiguration (without sync) for DAPS and security key refresh, retain/maintain/sustain (common) MAC, and
   for non-DAPS bearer: refresh of security and re-establishment of RLC and PDCP triggered by explicit L2 indicators;
   for DAPS bearer: establishment of second RLC for the PCell/PSCell, second security and second ROHC function; while maintaining common functions for reordering, duplicate detection and discard
   for SRB: refresh of security and establishment of RLC and PDCP for the target PCell;

Next, more details with regard to CellGroupConfig are provided, as described in section 6.3.2 of TS38.331, and as could be used for implementing one or more embodiments described above:

### CellGroupConfig

The CellGroupConfig 1E is used to configure a master cell group (MCG) or secondary cell group (SCG). A cell group comprises of one MAC entity, a set of logical channels with associated RLC entities and of a primary cell (SpCell) and one or more secondary cells (SCells).

### CellGroupConfig Information Element

-- ASN1START
-- TAG-CELLGROUPCONFIG-START
-- Configuration of one Cell-Group:

| | |
|---|---|
| CellGroupConfig ::= | SEQUENCE { |
| cellGroupId | CellGroupId, |
| rlc-BearerToAddModList | SEQUENCE (SIZE(1..maxLC-ID)) OF RLC-BearerConfig |

OPTIONAL, -- Need N

| | |
|---|---|
| rlc-BearerToReleaseList | SEQUENCE (SIZE(1..maxLC-ID)) OF LogicalChannelI- |
| dentity | OPTIONAL, -- Need N |
| mac-CellGroupConfig | MAC-CellGroupConfig |

OPTIONAL, -- Need M

| | |
|---|---|
| physicalCellGroupConfig | PhysicalCellGroupConfig |

OPTIONAL, -- Need M

| | |
|---|---|
| spCellConfig | SpCellConfig |

OPTIONAL, -- Need M

| | |
|---|---|
| sCellToAddModList | SEQUENCE (SIZE (1..maxNrofSCells)) OF SCellConfig |

OPTIONAL, -- Need N

| | |
|---|---|
| sCellToReleaseList | SEQUENCE (SIZE (1..maxNrofSCells)) OF SCellIndex |

OPTIONAL, -- Need N
...,
[[

| | |
|---|---|
| reportUplinkTxDirectCurrent | ENUMERATED {true} |

OPTIONAL -- Cond BWP-Reconfig
]],
[[

| | |
|---|---|
| bap-Address-r16 | BIT STRING (SIZE (10)) |

OPTIONAL, -- Need M

| | |
|---|---|
| bh-RLC-ChannelToAddModList-r16 | SEQUENCE (SIZE(1..maxBH-RLC-ChannelID-r16)) OF |

```
  BH-RLC-ChannelConfig-r16
  OPTIONAL, -- Need N
```

| | |
|---|---|
| bh-RLC-ChannelToReleaseList-r16 | SEQUENCE (SIZE(1..maxBH-RLC-ChannelID-r16)) OF |

```
  BH-RLC-ChannelID-r16
  OPTIONAL, -- Need N
```

| | |
|---|---|
| f1c-TransferPath-r16 | ENUMERATED {lte, nr, both} |

OPTIONAL, -- Need M

| | |
|---|---|
| simultaneousTCI-UpdateList1-r16 | SEQUENCE (SIZE (1..maxNrofServingCellsTCI-r16)) OF |
| ServCellIndex | OPTIONAL, -- Need R |
| simultaneousTCI-UpdateList2-r16 | SEQUENCE (SIZE (1..maxNrofServingCellsTCI-r16)) OF |
| ServCellIndex | OPTIONAL, -- Need R |
| simultaneousSpatial-UpdatedList1-r16 | SEQUENCE (SIZE (1..maxNrofServingCellsTCI-r16)) |
| OF ServCellIndex | OPTIONAL, -- Need R |
| simultaneousSpatial-UpdatedList2-r16 | SEQUENCE (SIZE (1..maxNrofServingCellsTCI-r16)) |
| OF ServCellIndex | OPTIONAL, -- Need R |
| uplinkTxSwitchingOption-r16 | ENUMERATED {switchedUL, dualUL} |

OPTIONAL, -- Need R

| | |
|---|---|
| uplinkTxSwitchingPowerBoosting-r16 | ENUMERATED {enabled} |

```
  OPTIONAL -- Need R
]],
[[
reportUplinkTxDirectCurrentTwoCarrier-r16 ENUMERATED {true}
  OPTIONAL -- Need N
]]
}
-- Serving cell specific MAC and PHY parameters for a SpCell:
```

| | |
|---|---|
| SpCellConfig ::= | SEQUENCE { |
| servCellIndex | ServCellIndex |

OPTIONAL, -- Cond SCG

| | |
|---|---|
| reconfigurationWithSync | ReconfigurationWithSync |

OPTIONAL, -- Cond ReconfWithSync

| | |
|---|---|
| rlf-TimersAndConstants | SetupRelease { RLF-TimersAndConstants } |

OPTIONAL, -- Need M

| | |
|---|---|
| rlmInSyncOutOfSyncThreshold | ENUMERATED {n1} |

OPTIONAL, -- Need S

| | |
|---|---|
| spCellConfigDedicated | ServingCellConfig |

OPTIONAL, -- Need M
...
}

| | |
|---|---|
| ReconfigurationWithSync ::= | SEQUENCE { |
| spCellConfigCommon | ServingCellConfigCommon |

OPTIONAL, -- Need M

| | |
|---|---|
| newUE-Identity | RNTI-Value, |
| t304 | ENUMERATED {ms50, ms100, ms150, ms200, ms500, |

ms1000, ms2000, ms10000},

| | |
|---|---|
| rach-ConfigDedicated | CHOICE { |
| uplink | RACH-ConfigDedicated, |
| supplementaryUplink | RACH-ConfigDedicated |

```
  }
  OPTIONAL, -- Need N
...,
[[
```

| | |
|---|---|
| smtc | SSB-MTC |

OPTIONAL -- Need S
]],
[[

| | |
|---|---|
| daps-UplinkPowerConfig-r16 | DAPS-UplinkPowerConfig-r16 |

OPTIONAL -- Need N
]]
}

| | |
|---|---|
| DAPS-UplinkPowerConfig-r16 ::= | SEQUENCE { |
| p-DAPS-Source-r16 | P-Max, |
| p-DAPS-Target-r16 | P-Max, |
| uplinkPowerSharingDAPS-Mode-r16 | ENUMERATED {semi-static-mode1, semi-static-mode2, |

dynamic }
}

| | |
|---|---|
| SCellConfig ::= | SEQUENCE { |
| sCellIndex | SCellIndex, |
| sCellConfigCommon | ServingCellConfigCommon |
| OPTIONAL, -- Cond | SCellAdd |
| sCellConfigDedicated | ServingCellConfig |
| OPTIONAL, -- Cond | SCellAddMod |

...,
[[

| | |
|---|---|
| smtc | SSB-MTC |

OPTIONAL -- Need S
]],
[[

| | |
|---|---|
| sCellState-r16 | ENUMERATED {activated} |

OPTIONAL, -- Cond SCellAddSync

| | |
|---|---|
| secondaryDRX-GroupConfig-r16 | ENUMERATED {true} |

OPTIONAL -- Cond DRX-Config2
]]}
-- TAG-CELLGROUPCONFIG-STOP
-- ASN1STOP

SpCellConfig field descriptions

reconfigurationWithSync
Parameters for the synchronous reconfiguration to the target SpCell.
rlf-TimersAndConstants
Timers and constants for detecting and triggering cell-level radio link
failure. For the SCG, rlf-TimersAndConstants can only be set to setup and
is always included at SCG addition.
servCellIndex
Serving cell ID of a PSCell. The PCell of the Master Cell Group uses
ID = 0.

| Conditional Presence | |
|---|---|
| Explanation | Explanation |
| BWP-Reconfig | The field is optionally present, Need N, if the BWPs are reconfigured |
| | or if serving cells are added or removed. Otherwise it is absent |
| DRX-Config2 | The field is optionally present, Need N, if drx-ConfigSecondaryGroup |
| | is configured. It is absent otherwise. |
| ReconfWithSync | The field is mandatory present in the RRCReconfiguration message: |
| | in each configured CellGroupConfig for which the SpCell changes, |
| | in the masterCellGroup: |
| | at change of AS security key derived from KgNB, |
| | in an RRCReconfiguration message contained in a |
| | DLInformationTransferMRDC message, |
| | in the secondaryCellGroup at: |
| | PSCell addition, |
| | SCG resume with NR-DC or (NG)EN-DC, |
| | update of required SI for PSCell, |
| | change of AS security key derived from S-KgNB in NR-DC |
| | while the UE is configured with at least one radio bearer |
| | with keyToUse set to secondary and that is not released by |
| | this RRCReconfiguration message, |
| | MN handover in (NG)EN-DC. |
| | Otherwise, it is optionally present, need M. The field is absent in |
| | the masterCellGroup in RRCResume and RRCSetup messages and |
| | is absent in the masterCellGroup in RRCReconfiguration messages |
| | if source configuration is not released during DAPS handover and |
| | is absent in SCG Config with DAPS and retained/maintained/sustained |
| | MAC (during MN handover (with SN maintained)). |
| SCellAdd | The field is mandatory present upon SCell addition; otherwise it is |
| | absent, Need M. |
| SCellAddMod | The field is mandatory present upon SCell addition; otherwise it is |
| | optionally present, need M. |
| SCellAddSync | The field is optionally present, Need N, in case of SCell addition, |
| | reconfiguration with sync, and resuming an RRC connection. It is |
| | absent otherwise. |
| SCG | The field is mandatory present in an SpCellConfig for the PSCell. It |
| | is absent otherwise. |

NOTE:
In case of change of AS security key derived from S-KgNB/S-KeNB, if reconfigurationWith Sync is not included in the masterCellGroup, the network releases all existing MCG RLC bearers associated with a radio bearer with keyToUse set to secondary. In case of change of AS security key derived from KgNB/KeNB, if reconfigurationWithSync is not included in the secondaryCellGroup, the network releases all existing SCG RLC bearers associated with a radio bearer with keyToUse set to primary.

It is particularly noticeable that, according to various embodiments, the ReconfWithSync may be absent in SCG Config with DAPS and retained/maintained/sustained MAC (during MN handover (with SN maintained)).

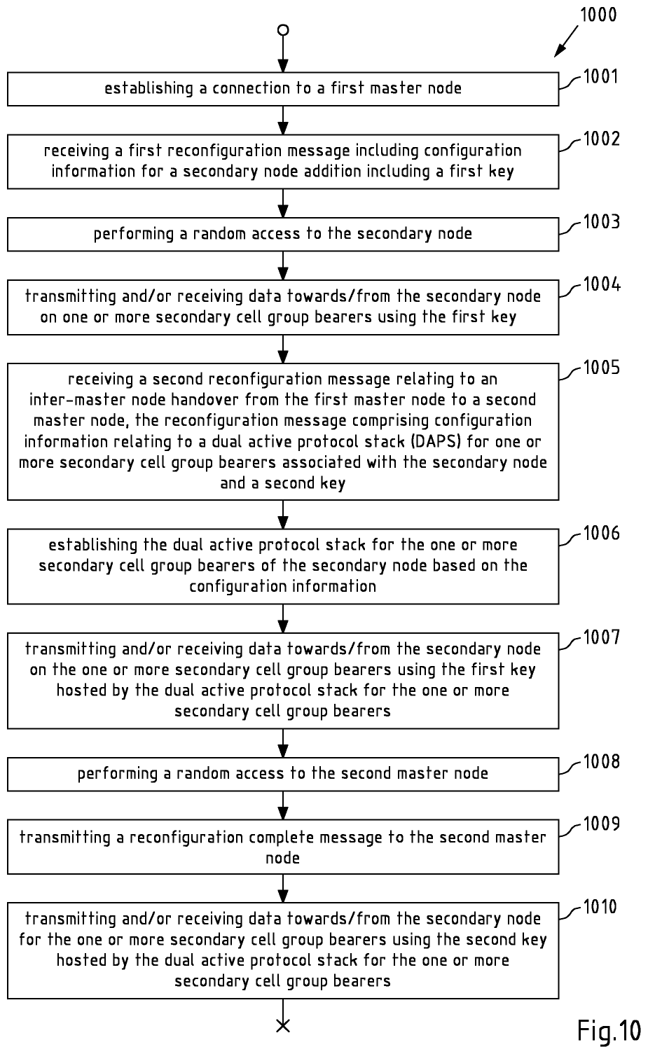

Flowcharts showing steps of embodiments according to the first to fourth example aspects will now be described with reference to FIGS. 10-13. In various embodiments, steps within a flowchart may be performed one after another in the order shown in the respective flowchart. They may also be performed in reaction and/or in response to one another. In other embodiments, steps of a flowchart may be performed in an order different than that shown in the respective flowchart. Further, in various embodiments, some steps shown within a flowchart may also be performed essentially simultaneously.

FIG. 10 shows a flowchart 1000 showing steps of an embodiment according to the first example aspect. One or more or all steps of flowchart 1000 may be performed by a user equipment.

Step 1001 comprises establishing a connection to a first master node. The first master node may act as a source master node of an inter-master node handover later on.

Step 1002 comprises receiving a first reconfiguration message including configuration information for a secondary node addition including a first key.

Step 1003 comprises performing a random access to the secondary node. Step 1003 may be carried out in reaction to step 1002.

Step 1004 comprises transmitting and/or receiving data towards/from the secondary node on one or more secondary cell group bearers using the first key, e.g. using a single protocol stack. Thus, for instance, no dual active protocol stack is used in this step for the transmitting and/or receiving of data.

Step 1005 comprises receiving a second reconfiguration message relating to an inter-master node handover from the first master node to a second master node, the reconfiguration message comprising configuration information relating to a dual active protocol stack (DAPS) for one or more secondary cell group bearers associated with the secondary node and a second key.

Step 1006 comprises establishing the dual active protocol stack for the one or more secondary cell group bearers of the secondary node based on the configuration information. The establishing may be triggered by the received configuration information, e.g. if one or more further conditions are met.

In various embodiments, the reconfiguration message comprising the configuration information may be a RRC Reconfiguration message. It may e.g. comprise an HO container comprising a MCG configuration and a SCG configuration without a reconfWithSync and with a DAPS configuration (SCG-RB-Config-DAPS) with a parameter indicating to retain a MAC. In other embodiments, the configuration information may be a HO container comprising a MCG configuration and a SCG configuration with a DAPS configuration (SCG-RB-Config-DAPS), possibly with a reconfWithSync and e.g. without a parameter indicating to retain a MAC.

Step 1007 comprises transmitting and/or receiving data towards/from the secondary node on the one or more secondary cell group bearers using the first key hosted by the dual active protocol stack for the one or more secondary cell group bearers. As step 1007 makes use of the dual active protocol stack established in step 1006, it may happen after step 1006. However, it is to be understood that also before step 1006 transmitting and/or receiving data on the one or more secondary cell group bearers using a first key, e.g. hosted by a single protocol stack, may be possible, as described in step 1004.

Step 1008 comprises performing a random access to the second master node. This may have been part of the process triggered by step 1005. The second master node may be acting as a target master node of the inter-master node handover.

Step 1009 comprises transmitting a reconfiguration complete message to the second master node. This message may indicate to the target MN that the reconfiguration, e.g. as requested in step 1005, has been completed.

Step 1010 comprises transmitting and/or receiving data towards/from the secondary node for the one or more secondary cell group bearers using the second key hosted by the dual active protocol stack for the one or more secondary cell group bearers.

In various embodiments, in particular in embodiments where no DAPS with a common MAC entity is used, there may be a time interval where steps 1007 and 1010 overlap. The time interval may e.g. start after a random access procedure from the UE to a SCG or the associated SN has been completed and it may e.g. end when a UE receives a reconfiguration message from the SN indicating to release those parts of the DAPS that relate to a source PS and, thus, e.g. a source MN.

In various embodiments, in particular in embodiments where a DAPS with a common MAC entity is used, step 1007 may be performed first (after step 1006). Then, the UE may complete steps 1008 and 1009 and/or receive data on the one or more secondary cell group bearers using a second key hosted by the dual active protocol stack for the one or more secondary cell group bearers according to step 1007. One or more of these actions may trigger the UE to switch the key and start transmitting data on the one or more secondary cell group bearers using the second key hosted by the dual active protocol stack for the one or more secondary cell group bearers according to step 1010. At that time, step 1007 may be finished.

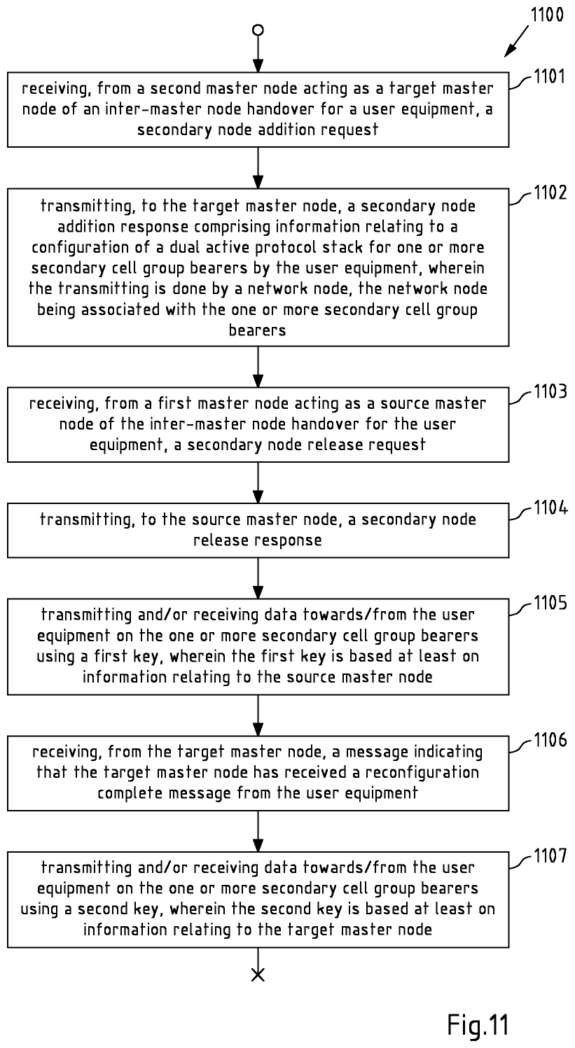

FIG. 11 shows a flowchart 1100 showing steps of an embodiment according to the second example aspect. One or more or all steps of flowchart 1000 may be performed by a network node, e.g. a network node acting as a secondary node.

Step 1101 comprises receiving, from a second master node acting as a target master node of an inter-master node handover for a user equipment, a secondary node addition request.

Step 1102 comprises transmitting, to the target master node, a secondary node addition response comprising information relating to a configuration of a dual active protocol stack for one or more secondary cell group bearers by the user equipment, wherein the transmitting is done by a network node, the network node being associated with the one or more secondary cell group bearers.

The information may be at least part of the configuration information referred to in step 1005. More specifically, in various embodiments, the information may be comprised in a SN addition response that e.g. comprises a SCG configuration without a reconfWithSync and with a DAPS configuration (SCG-RB-Config-DAPS) with a parameter indicating to retain a MAC. In other embodiments, the information may be a SCG configuration with a DAPS configuration (SCG-RB-Config-DAPS), possibly with a reconfWithSync and e.g. without a parameter indicating to retain a MAC.

Step 1103 comprises receiving, from a first master node acting as a source master node of the inter-master node handover for the user equipment, a secondary node release request.

Step 1104 comprises transmitting, to the source master node, a secondary node release response.

Step 1105 comprises transmitting and/or receiving data towards/from the user equipment on the one or more secondary cell group bearers using a first key, wherein the first key is based at least on information relating to the source master node.

Step 1106 comprises receiving, from the target master node, a message indicating that the target master node has received a reconfiguration complete message from the user equipment.

Step 1107 comprises transmitting and/or receiving data towards/from the user equipment on the one or more secondary cell group bearers using a second key, wherein the second key is based at least on information relating to the target master node.

Steps 1105 and 1107 may be considered to be the counterparts of steps 1007 and 1010, respectively. Accordingly, the explanations made with regard to the relation between steps 1007 and 10010 apply similarly to the relation between steps 1105 and 1107.

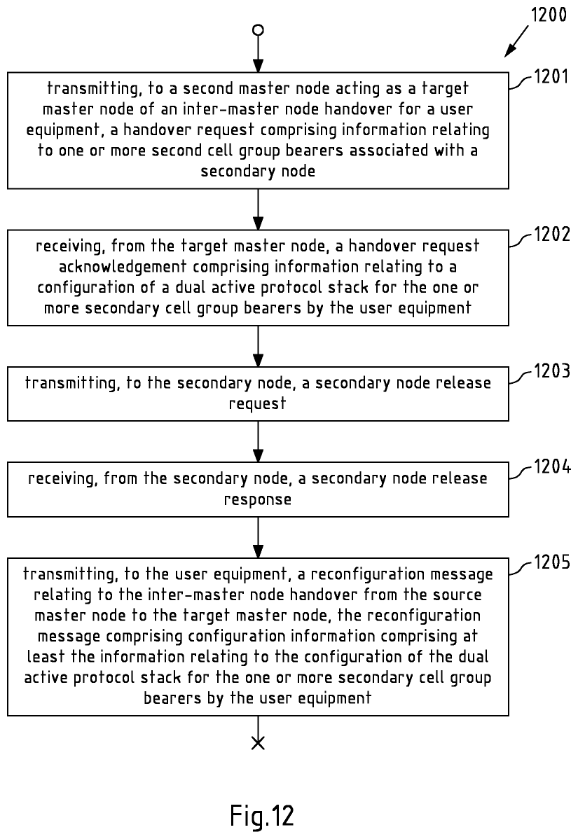

FIG. 12 shows a flowchart 1200 showing steps of an embodiment according to the third example aspect. One or more or all steps of flowchart 1000 may be performed by a network node, e.g. a network node acting as a source MN of an inter-MN HO.

Step 1201 comprises transmitting, to a second master node acting as a target master node of an inter-master node handover for a user equipment, a handover request comprising information relating to one or more second cell group bearers associated with a secondary node.

Step 1202 comprises receiving, from the target master node, a handover request acknowledgement comprising information relating to a configuration of a dual active protocol stack for the one or more secondary cell group bearers by the user equipment.

In various embodiments, the handover request acknowledgement may comprise or correspond to a HO container comprising a MCG configuration and a SCG configuration without a reconfWithSync and with a DAPS configuration (SCG-RB-Config-DAPS) with a parameter indicating to retain a MAC. In other embodiments, the handover request acknowledgement may be a HO container comprising a MCG configuration and a SCG configuration with a DAPS configuration (SCGRB-Config-DAPS), possibly with a reconfWithSync and e.g. without a parameter indicating to retain a MAC.

Step 1203 comprises transmitting, to the secondary node, a secondary node release request.

Step 1204 comprises receiving, from the secondary node, a secondary node release response.

Step 1205 comprises transmitting, to the user equipment, a reconfiguration message relating to the inter-master node handover from the source master node to the target master node, the reconfiguration message comprising configuration information comprising at least the information relating to the configuration of the dual active protocol stack for the one or more secondary cell group bearers by the user equipment. The configuration information may comprise at least the HO container as described above.

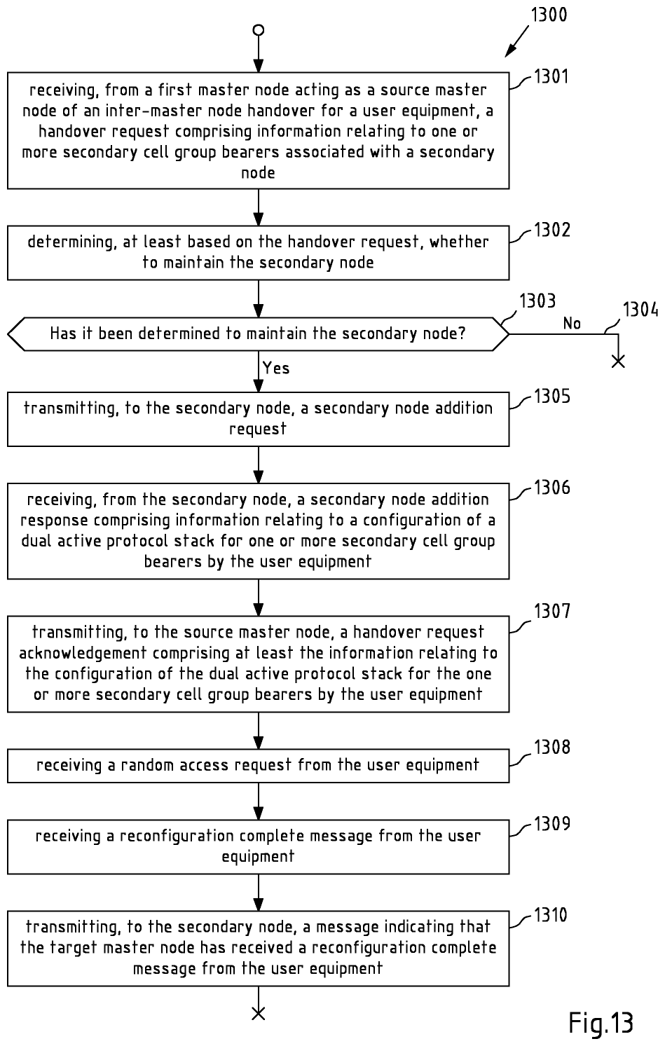

FIG. 13 shows a flowchart 1300 showing steps of an embodiment according to the fourth example aspect One or more or all steps of flowchart 1000 may be performed by a network node, e.g. a network node acting as a target MN of an inter-MN HO.

Step 1301 comprises receiving, from a first master node acting as a source master node of an inter-master node handover for a user equipment, a handover request comprising information relating to one or more secondary cell group bearers associated with a secondary node.

Step 1301 may be considered to be the counterpart to step 1201 described above.

Step 1302 comprises determining, at least based on the handover request, whether to maintain the secondary node.

If it has been determined not to maintain the SN (step 1303), the inter-MN HO procedure involving use of a DAPS for one or more SCG bearers by the UE may be aborted (step 1304) and/or another inter-MN HO procedure may be conducted.

It if has been determined to maintain the SN (step 1303) the steps 1305 to 1310 may be carried out. However, there may be further conditions for deciding whether steps 1305 to 1310 or step 1304 is carried out Thus, in various embodiments, even though it has been determined to maintain the secondary node, step 1304 may be carried out instead of steps 1305 to 1310, for example because another condition for carrying out steps 1305 to 1310 has not been met.

Step 1305 comprises transmitting, to the secondary node, a secondary node addition request.

Step 1306 comprises receiving, from the secondary node, a secondary node addition response comprising information relating to a configuration of a dual active protocol stack for one or more secondary cell group bearers by the user equipment.

Step 1306 may be considered to be the counterpart to step 1102 described above. Thus, the description provided in the context of step 1102 also applies to step 1306.

Step 1307 comprises transmitting, to the source master node, a handover request acknowledgement comprising at least the information relating to the configuration of the dual active protocol stack for the one or more secondary cell group bearers by the user equipment.

It is to be noticed that in various embodiments of step 1307, the network node may not only provide the information relating to the configuration of the dual active protocol stack for the one or more secondary cell group bearers by the user equipment received in step 1306. Additionally, the network node may provide, to the source master node of the inter-master node handover, further information, e.g. a MCG configuration.

Step 1307 may be considered to be the counterpart to step 1202 described above. Thus, the description provided in the context of step 1202 also applies to step 1307.

Step 1308 comprises receiving a random access request from the user equipment. This step may be part of the inter-MN HO and it may e.g. happen after the UE has initiated the DAPS and e.g. before the UE and the SN start transmitting and/or receiving data using the second key.

Step 1309 comprises receiving a reconfiguration complete message from the user equipment.

Step 1310 comprises transmitting, to the secondary node, a message indicating that the target master node has received a reconfiguration complete message from the user equipment, e.g. a SgNB reconfiguration complete message.

Further, the following embodiments are disclosed:

### Embodiment 1

A method, e.g. performed by a user equipment, the method comprising:
establishing a connection to a first master node,
receiving a first reconfiguration message including configuration information for a secondary node addition including a first key,
performing a random access to the secondary node,
transmitting and/or receiving data towards/from the secondary node on one or more secondary cell group bearers using the first key,
receiving a second reconfiguration message relating to an inter-master node handover from the first master node to a second master node, the reconfiguration message comprising configuration information relating to a dual active protocol stack (DAPS) for one or more secondary cell group bearers associated with the secondary node and a second key;
establishing the dual active protocol stack for the one or more secondary cell group bearers of the secondary node based on the configuration information;
transmitting and/or receiving data towards/from the secondary node on the one or more secondary cell group bearers using the first key hosted by the dual active protocol stack for the one or more secondary cell group bearers;
performing a random access to the second master node;
transmitting a reconfiguration complete message to the second master node; and
transmitting and/or receiving data towards/from the secondary node for the one or more secondary cell group bearers using the second key hosted by the dual active protocol stack for the one or more secondary cell group bearers.

### Embodiment 2

The method of embodiment 1, further comprising:
transmitting a measurement report to the first master node to trigger handover.

### Embodiment 3

The method of any of embodiments 1 or 2, wherein the second reconfiguration message comprises: Master Cell Group (MCG) configuration information, Secondary Cell Group (SCG) configuration information without reconfig with Sync, and SCG Radio Bearer (RB) configuration for DAPS with Medium Access Control (MAC) retained.

### Embodiment 4

The method of any of embodiments 1 to 3, further comprising:
configuring for the secondary node (SN) connection during handover a DAPS Packet Data Convergence Protocol (PDCP) hosting two security layers for ciphering and integrity protection: a first layer using the first SN key derived from a first Master node (MN) key and a second layer using the second SN key derived from a second MN key.

### Embodiment 5

The method of any of embodiments 1 to 4, further comprising:
configuring for the secondary node (SN) connection during handover a DAPS Packet Data Convergence Protocol (PDCP) hosting two different security layers and one common Medium Access Control (MAC) layer.

### Embodiment 6

The method of any of embodiments 1 to 5, further comprising:
receiving a third reconfiguration message including information related to release of the first master node, and
configuring for the secondary node (SN) connection a Packet Data Convergence Protocol (PDCP) hosting the second key.

### Embodiment 7

The method of any of embodiments 1 to 6, further comprising:
using a common medium access control entity for the transmitting and/or receiving of the data towards/from the secondary node on the one or more secondary cell group bearers using the first key hosted by the dual active protocol stack and for the transmitting and/or receiving of the data towards/from the secondary node on the one or more secondary cell group bearers using the second key hosted by the dual active protocol stack.

### Embodiment 8

The method of embodiment 7, further comprising:
determining, based at least on the configuration information comprised in the second reconfiguration message, whether to use the common medium access control entity or whether to reset the medium access control entity after the transmitting and/or receiving of the data towards/from the secondary node on the one or more secondary cell group bearers using the first key hosted by the dual active protocol stack and/or before the transmitting and/or receiving of the data towards/from the secondary node on the one or more secondary cell group bearers using the second key hosted by the dual active protocol stack.

### Embodiment 9

The method of any of embodiments 1 to 8, further comprising:
switching from the transmitting of the data towards the secondary node for the one or more secondary cell group bearers using the first key hosted by the dual active protocol stack to the transmitting of the data towards the secondary node for the one or more secondary cell group bearers using the second key hosted by the dual active protocol stack after the random access to the second master node has been completed and after the reconfiguration complete message has been transmitted to the second master node.

### Embodiment 10

The method of any of embodiments 1 or 2, further comprising:
performing a random access to the secondary node associated with the one or more secondary cell group bearers; and
starting the transmitting and/or receiving of the data towards/from the secondary node on the one or more secondary cell group bearers using the second key hosted by the dual active protocol stack after the random access to the second master node and the random access to the secondary node have been completed.

### Embodiment 11

The method of any of embodiments 1 to 10, further comprising:
receiving a reconfiguration message from the secondary node associated with the one or more secondary cell group bearers, the reconfiguration message comprising configuration information relating to a use of a single protocol stack for the one or more secondary cell group bearers;
based at least on the configuration information received from the secondary node, initiating the use of the single protocol stack for transmitting and/or receiving data towards/from the secondary node on the one or more secondary cell group bearers using the second key; and
transmitting a reconfiguration complete message to the secondary node.

### Embodiment 12

A method, e.g. performed by a user equipment, the method comprising:
establishing a connection to a first network node,
receiving a first reconfiguration message including configuration information including a first key,
transmitting and/or receiving data towards/from the first network node on one or more bearers using the first key,
receiving a second reconfiguration message comprising configuration information relating to a dual active protocol stack (DAPS) for one or more bearers associated with the first network node and a second key;
establishing the dual active protocol stack for the one or more bearers of the first network node based on the configuration information and configure for the first network node connection a DAPS Packet Data Convergence Protocol (PDCP) hosting two different security layers with the first and the second keys and one common Medium Access Control (MAC) layer,
transmitting and/or receiving data towards/from the first network node on the one or more bearers using the first key hosted by the dual active protocol stack for the one or more bearers; and
transmitting and/or receiving data towards/from the first network node for the one or more bearers using the second key hosted by the dual active protocol stack for the one or more bearers.

### Embodiment 13

The method according to embodiment 12, further comprising:
operating in dual connectivity connection with a first master node and a secondary node, wherein the first reconfiguration message is received from the first master node, wherein the second reconfiguration message is received from the first master node and comprises configuration information relating to a handover from the first master node to a second master node while maintaining connection to the secondary node, and wherein the first network node is the secondary node.

### Embodiment 14

A method, e.g. performed by a network node, the method comprising:
receiving, from a second master node acting as a target master node of an inter-master node handover for a user equipment, a secondary node addition request;
transmitting, to the target master node, a secondary node addition response comprising information relating to a configuration of a dual active protocol stack for one or more secondary cell group bearers by the user equipment, wherein the transmitting is done by a network node, the network node being associated with the one or more secondary cell group bearers;
receiving, from a first master node acting as a source master node of the inter-master node handover for the user equipment, a secondary node release request;
transmitting, to the source master node, a secondary node release response;
transmitting and/or receiving data towards/from the user equipment on the one or more secondary cell group bearers using a first key, wherein the first key is based at least on information relating to the source master node;
receiving, from the target master node, a message indicating that the target master node has received a reconfiguration complete message from the user equipment; and
transmitting and/or receiving data towards/from the user equipment on the one or more secondary cell group bearers using a second key, wherein the second key is based at least on information relating to the target master node.

### Embodiment 15

The method of embodiment 14, further comprising:
receiving, from the source master node, a secondary node modification request;
transmitting, to the source master node, a secondary node modification response comprising information relating to the one or more secondary cell group bearers.

### Embodiment 16

The method of any of embodiments 14 to 15, further comprising:
switching from the transmitting of the data towards the secondary node on the one or more secondary cell group bearers using the first key to the transmitting of the data towards the secondary node on the one or more secondary cell group bearers using the second key after the message indicating that the target master node has received the reconfiguration complete message from the user equipment has been received.

### Embodiment 17

The method of any of embodiments 14 to 15, further comprising:
receiving a random access request from the user equipment; and
starting the transmitting and/or receiving of the data towards/from the secondary node on the one or more secondary cell group bearers using the second key after a random access with the user equipment based on the received random access request has been completed and after the message indicating that the target master node has received the reconfiguration complete message from the user equipment has been received.

### Embodiment 18

The method of any of embodiments 14 to 17, further comprising:
transmitting, to the user equipment, a reconfiguration message comprising configuration information relating to a use of a single protocol stack for the one or more secondary cell group bearers; and
receiving, from the user equipment, a reconfiguration complete message.

### Embodiment 19

A method, e.g. performed by a network node, the method comprising:
transmitting, to a second master node acting as a target master node of an inter-master node handover for a user equipment, a handover request comprising information relating to one or more second cell group bearers associated with a secondary node;
receiving, from the target master node, a handover request acknowledgement comprising information relating to a configuration of a dual active protocol stack for the one or more secondary cell group bearers by the user equipment;
transmitting, to the secondary node, a secondary node release request;
receiving, from the secondary node, a secondary node release response; and
transmitting, to the user equipment, a reconfiguration message relating to the inter-master node handover from the source master node to the target master node, the reconfiguration message comprising configuration information comprising at least the information relating to the configuration of the dual active protocol stack for the one or more secondary cell group bearers by the user equipment.

### Embodiment 20

The method of embodiment 19, further comprising:
receiving, from the user equipment, a measurement report;
triggering, based on the measurement report, the inter-master node handover.

### Embodiment 21

The method of any of embodiments 19 to 20, further comprising:
transmitting, to the secondary node, a secondary node modification request;
receiving, from the secondary node, a secondary node modification response comprising the information relating to the one or more secondary cell group bearers associated with the secondary node.

### Embodiment 22

A method, e.g. performed by a network node, the method comprising:
receiving, from a first master node acting as a source master node of an inter-master node handover for a user equipment, a handover request comprising information relating to one or more secondary cell group bearers associated with a secondary node;
determining, at least based on the handover request, whether to maintain the secondary node;
on condition that it has been determined to maintain the secondary node:
   transmitting, to the secondary node, a secondary node addition request;
   receiving, from the secondary node, a secondary node addition response comprising information relating to a configuration of a dual active protocol stack for one or more secondary cell group bearers by the user equipment;
   transmitting, to the source master node, a handover request acknowledgement comprising at least the information relating to the configuration of the dual active protocol stack for the one or more secondary cell group bearers by the user equipment:
   receiving a random access request from the user equipment;
   receiving a reconfiguration complete message from the user equipment; and
   transmitting, to the secondary node, a message indicating that the target master node has received a reconfiguration complete message from the user equipment.

### Embodiment 23

The method of any of embodiments 1 to 22, wherein the information relating to the configuration of the dual active protocol stack indicate whether a common medium access control entity is to be used by the user equipment for transmitting and/or receiving of data towards/from the secondary node on the one or more secondary cell group bearers using a first key and for transmitting and/or receiving of data towards/from the secondary node on the one or more secondary cell group bearers using a second key.

### Embodiment 24

The method of any of embodiments 1 to 23, wherein the information relating to the configuration of the dual active protocol stack comprise information for the user equipment for using a common medium access control entity for the transmitting and/or receiving of the data towards/from the secondary node on the one or more secondary cell group bearers using the first key and for the transmitting and/or receiving of the data towards/from the secondary node on the one or more secondary cell group bearers using the second key.

### Embodiment 25

An apparatus comprising at least one processor; and at least one memory including computer program code; the at least one memory and the computer program code configured to, with the at least one processor, cause the apparatus at least to perform the method of any of embodiments 1 to 24.

### Embodiment 26

An apparatus comprising means configured to perform the method of any of embodiments 1 to 24.

### Embodiment 27

The apparatus of any of embodiments 25 or 26, wherein the apparatus is a or the user equipment.

### Embodiment 28

The apparatus of any of embodiments 25 to 26, wherein the apparatus is a or the network node.

### Embodiment 29

A system comprising at least the following apparatuses:
the apparatus of any of embodiments 25 to 28, performing at least the method of any of embodiments 1 to 13;
the apparatus of any of embodiments 25 to 28, performing at least the method of any of embodiments 14 to 18;
the apparatus of any of embodiments 25 to 28, performing at least the method of any of embodiments 19 to 21;
the apparatus of any of embodiments 25 to 28, performing at least the method of embodiment 22.

### Embodiment 28

A computer-readable medium storing computer program code, the computer program code when executed by a processor causing an apparatus, e.g. the apparatus of any of embodiments 25 to 28, to perform and/or control the method of any of embodiments 1 to 24.

### Embodiment 29

A computer program, the computer program when executed by a processor causing an apparatus, e.g. the apparatus of any of embodiments 25 to 28, to perform and/or control the method of any of embodiments 1 to 24.

The means referred to above can be implemented in hardware. It may comprise for instance at least one processor for executing computer program code for performing the required function, at least one memory storing the program code and/or data, or both. Additionally or alternatively, it may for instance comprise circuitry that is designed to implement functions, for instance implemented in a chipset or a chip, like an integrated circuit. The means may comprise for instance one or more processing means or processors.

The computer program may be stored on computer-readable storage medium, in particular a tangible and/or non-transitory medium. The computer readable storage medium could for example be a disk or a memory or the like. The computer program could be stored in the computer readable storage medium in the form of instructions encoding the computer-readable storage medium. The computer readable storage medium may be intended for taking part in the operation of a device, like an internal or external memory (e.g. a Read-Only Memory (ROM) or hard disk of a computer, or be intended for distribution of the program, like an optical disc.

The following description may provide further details of alternatives, modifications and variances of a base station embodied e.g. as a gNB: A gNB comprises e.g. a node providing NR user plane and control plane protocol terminations towards the UE, and connected via the NG interface to the 5GC, e.g. according to 3GPP TS 38.300 V16.6.0 (2021-06) section 3.2 incorporated by reference.

A gNB Central Unit (gNB-CU) comprises e.g. a logical node hosting e.g. RRC, SDAP and PDCP protocols of the gNB or RRC and PDCP protocols of the en-gNB that controls the operation of one or more gNB-DUs. The gNB-CU terminates the F1 interface connected with the gNB-DU.

A gNB Distributed Unit (gNB-DU) comprises e.g. a logical node hosting e.g. RLC, MAC and PHY layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

A gNB-CU-Control Plane (gNB-CU-CP) comprises e.g. a logical node hosting e.g. the RRC and the control plane part of the PDCP protocol of the gNB-CU for an en-gNB or a gNB. The gNB-CU-CP terminates the E1 interface connected with the gNB-CU-UP and the F1-C interface connected with the gNB-DU.

A gNB-CU-User Plane (gNB-CU-UP) comprises e.g. a logical node hosting e.g. the user plane part of the PDCP protocol of the gNB-CU for an en-gNB, and the user plane part of the PDCP protocol and the SDAP protocol of the gNB-CU for a gNB. The gNB-CU-UP terminates the E1 interface connected with the gNB-CU-CP and the F1-U interface connected with the gNB-DU, e.g. according to 3GPP TS 38.401 V16.6.0 (2021-07) section 3.1 incorporated by reference.

Different functional splits between the central and distributed unit are possible, e.g. called options:

### Option 1 (1A-Like Split)

The function split in this option is similar as 1A architecture in DC. RRC is in the central unit PDCP, RLC, MAC, physical layer and RF are in the distributed unit.

### Option 2 (3C-Like Split)

The function split in this option is similar as 3C architecture in DC. RRC, PDCP are in the central unit RLC, MAC, physical layer and RF are in the distributed unit.

### Option 3 (Intra RLC Split)

Low RLC (partial function of RLC), MAC, physical layer and RF are in the distributed unit PDCP and high RLC (the other partial function of RLC) are in the central unit.

### Option 4 (RLC-MAC Split)

MAC, physical layer and RF are in the distributed unit PDCP and RLC are in the central unit.

Or else, e.g. according to 3GPP TR 38.801 V14.0.0 (2017-03) section 11 incorporated by reference.

A gNB supports different protocol layers, e.g. Layer 1 (L1), Layer 2 (L2), Layer 3 (L3).

Layer 1 (L1)—physical layer.

The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC QoS flows;
Comp. refers to header compression and segm. to segmentation;
Control channels (BCCH, PCCH).

Layer 3 (L3) includes e.g. Radio Resource Control (RRC), e.g. according to 3GPP TS 38.300 V16.6.0 (2021-06) section 6 incorporated by reference.

A RAN (Radio Access Network) node or network node like e.g. a gNB, base station, gNB CU or gNB DU or parts thereof may be implemented using e.g. an apparatus with at least one processor and/or at least one memory (with computer-readable instructions (computer program)) configured to support and/or provision and/or processing of CU and/or DU related functionality and/or features, and/or at least one protocol (sub-)layer of a RAN (Radio Access Network), e.g. layer 2 and/or layer 3.

The gNB CU and gNB DU parts may e.g. be co-located or physically separated. gNB DU may even be split further, e.g. into two parts, e.g. one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof.

gNB-DU supports one or multiple cells, and could thus serve as e.g. a serving cell for user equipment (UE).

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g. configured to generate a message (e.g. including a cell ID) to be transmitted via radio towards a RAN (e.g. to reach and communicate with a serving cell). A UE may generate and transmit and receive RRC messages containing one or more RRC PDUs (Packet Data Units).

The UE may have different states (e.g. according to 3GPP TS 38.331 V16.5.0 (2021-06) sections 42.1 and 4.4, incorporated by reference).

A UE is e.g. either in RRC_CONNECTED state or in RRC_INACTIVE state when an RRC connection has been established.

In RRC_CONNECTED state a UE may:
store the AS context;
transfer of unicast data to/from UE;
Monitor control channels associated with the shared data channel to determine if data is scheduled for it;
provide channel quality and feedback information;
perform neighboring cell measurements and measurement reporting;

The RRC protocol includes e.g. the following main functions:
RRC connection control:
Measurement configuration and reporting:
Establishment/modification/release of measurement configuration (e.g. intra-frequency, inter-frequency and inter-RAT measurements);
Setup and release of measurement gaps;
Measurement reporting.

3GPP TS37.340 v16.7.0 (2021-09) describes e.g. in section 10.7 Inter-MN handover and in section 10.2 Secondary Node Addition procedures. These procedures are incorporated by reference.

1-29. (canceled)

30. A user equipment comprising at least one processor; and at least one memory including computer program code; the at least one memory and the computer program code configured to, with the at least one processor, cause the user equipment at least to perform the following:
establish a connection to a first master node,
receive a first reconfiguration message including configuration information for a secondary node addition including a first key,
perform a random access to the secondary node,
transmit and/or receive data towards/from the secondary node on one or more secondary cell group bearers using the first key,
receive a second reconfiguration message relating to an inter-master node handover from the first master node to a second master node, the reconfiguration message comprising configuration information relating to a dual active protocol stack (DAPS) for one or more secondary cell group bearers associated with the secondary node and a second key;
establish the dual active protocol stack for the one or more secondary cell group bearers of the secondary node based on the configuration information;
transmit and/or receive data towards/from the secondary node on the one or more secondary cell group bearers using the first key hosted by the dual active protocol stack for the one or more secondary cell group bearers;
perform a random access to the second master node;
transmit a reconfiguration complete message to the second master node; and
transmit and/or receive data towards/from the secondary node for the one or more secondary cell group bearers using the second key hosted by the dual active protocol stack for the one or more secondary cell group bearers.

31. The user equipment of claim 30, wherein the at least one memory and the computer pro-gram code are further configured to, with the at least one processor, cause the user equipment at least to perform the following:
transmit a measurement report to the first master node to trigger handover.

32. The user equipment of claim 30, wherein the second reconfiguration message comprises: Master Cell Group (MCG) configuration information, Secondary Cell Group (SCG) configuration information without reconfig with Sync, and SCG Radio Bearer (RB) configuration for DAPS with Medium Access Control (MAC) retained.

33. The user equipment of claim 30, wherein the at least one memory and the computer pro-gram code are further configured to, with the at least one processor, cause the user equipment at least to perform the following:
configure for the secondary node (SN) connection during handover a DAPS Packet Data Convergence Protocol (PDCP) hosting two security layers for ciphering and integrity protection: a first layer using the first SN key derived from a first Master node (MN) key and a second layer using the second SN key derived from a second MN key.

34. The user equipment of claim 30, wherein the at least one memory and the computer pro-gram code are further configured to, with the at least one processor, cause the user equipment at least to perform the following:
configure for the secondary node (SN) connection during handover a DAPS Packet Data Convergence Protocol (PDCP) hosting two different security layers and one com-mon Medium Access Control (MAC) layer.

35. The user equipment of claim 30, wherein the at least one memory and the computer pro-gram code are further configured to, with the at least one processor, cause the user equipment at least to perform the following:
receive a third reconfiguration message including information related to release of the first master node, and
configure for the secondary node (SN) connection a Packet Data Convergence Protocol (PDCP) hosting the second key.

36. The user equipment of claim 30, wherein the at least one memory and the computer pro-gram code are further configured to, with the at least one processor, cause the user equipment at least to perform the following:
use a common medium access control entity for the transmitting and/or receiving of the data towards/from the secondary node on the one or more secondary cell group bearers using the first key hosted by the dual active protocol stack and for the transmitting and/or receiving of the data towards/from the secondary node on the one or more secondary cell group bearers using the second key hosted by the dual active protocol stack.

37. The user equipment of claim 36, wherein the at least one memory and the computer pro-gram code are further configured to, with the at least one processor, cause the user equipment at least to perform the following:
determine, based at least on the configuration information comprised in the second reconfiguration message, whether to use the common medium access control entity or whether to reset the medium access control entity after the transmitting and/or receiving of the data towards/from the secondary node on the one or more secondary cell group bearers using the first key hosted by the dual active protocol stack and/or before the transmitting and/or receiving of the data towards/from the secondary node on the one or more secondary cell group bearers using the second key hosted by the dual active proto-col stack.

38. The user equipment of claim 30, wherein the at least one memory and the computer pro-gram code are further configured to, with the at least one processor, cause the user equipment at least to perform the following:
switch from the transmitting of the data towards the secondary node for the one or more secondary cell group bearers using the first key hosted by the dual active protocol stack to the transmitting of the data towards the secondary node for the one or more secondary cell group bearers using the second key hosted by the dual active protocol stack after the random access to the second master node has been completed and after the reconfiguration complete message has been transmitted to the second master node.

39. The user equipment of claim 30, wherein the at least one memory and the computer pro-gram code are further configured to, with the at least one processor, cause the user equipment at least to perform the following:
perform a random access to the secondary node associated with the one or more secondary cell group bearers; and
start the transmitting and/or receiving of the data towards/from the secondary node on the one or more secondary cell group bearers using the second key hosted by the dual active protocol stack after the random access to the second master node and the random access to the secondary node have been completed.

40. The user equipment of claim 30, wherein the at least one memory and the computer pro-gram code are further configured to, with the at least one processor, cause the user equipment at least to perform the following:
receive a reconfiguration message from the secondary node associated with the one or more secondary cell group bearers, the reconfiguration message comprising configuration information relating to a use of a single protocol stack for the one or more secondary cell group bearers;
based at least on the configuration information received from the secondary node, initiate the use of the single protocol stack for transmitting and/or receiving data towards/from the secondary node on the one or more secondary cell group bearers using the second key; and
transmit a reconfiguration complete message to the secondary node.

41. A user equipment comprising at least one processor; and at least one memory including computer program code; the at least one memory and the computer program code configured to, with the at least one processor, cause the user equipment at least to perform the following:
establish a connection to a first network node,
receive a first reconfiguration message including configuration information including a first key,
transmit and/or receive data towards/from the first network node on one or more bearers using the first key,
receive a second reconfiguration message comprising configuration information relating to a dual active protocol stack (DAPS) for one or more bearers associated with the first network node and a second key;
establish the dual active protocol stack for the one or more bearers of the first network node based on the configuration information and configure for the first network node connection a DAPS Packet Data Convergence Protocol (PDCP) hosting two different security layers with the first and the second keys and one common Medium Access Control (MAC) layer,
transmit and/or receive data towards/from the first network node on the one or more bearers using the first key hosted by the dual active protocol stack for the one or more bearers; and
transmit and/or receive data towards/from the first network node for the one or more bearers using the second key hosted by the dual active protocol stack for the one or more bearers.

42. The user equipment according to claim 41, wherein the user equipment is configured to operate in dual connectivity connection with a first master node and a secondary node, wherein the first reconfiguration message is received from the first master node,
wherein the second reconfiguration message is received from the first master node and comprises configuration information relating to a handover from the first master node to a second master node while maintaining connection to the secondary node, and wherein the first network node is the secondary node.

43. A method comprising:
establishing a connection to a first master node,
receiving a first reconfiguration message including configuration information for a secondary node addition including a first key,
performing a random access to the secondary node,
transmitting and/or receiving data towards/from the secondary node on one or more secondary cell group bearers using the first key,
receiving a second reconfiguration message relating to an inter-master node handover from the first master node to a second master node, the reconfiguration message comprising configuration information relating to a dual active protocol stack (DAPS) for one or more secondary cell group bearers associated with the secondary node and a second key;
establishing the dual active protocol stack for the one or more secondary cell group bearers of the secondary node based on the configuration information;
transmitting and/or receiving data towards/from the secondary node on the one or more secondary cell group bearers using the first key hosted by the dual active protocol stack for the one or more secondary cell group bearers;
performing a random access to the second master node;
transmitting a reconfiguration complete message to the second master node; and
transmitting and/or receiving data towards/from the secondary node for the one or more secondary cell group bearers using the second key hosted by the dual active protocol stack for the one or more secondary cell group bearers.
